(19) United States
(12) Patent Application Publication
(10) Pub. No.: US 2023/0028232 A1
(43) Pub. Date: Jan. 26, 2023

(54) CURABLE COMPOSITION

(71) Applicant: SUMITOMO CHEMICAL COMPANY, LIMITED, Tokyo (JP)

(72) Inventors: Michiru DAIMON, Osaka-shi (JP); Yasuharu SHIMAZAKI, Osaka-shi (JP)

(73) Assignee: SUMITOMO CHEMICAL COMPANY, LIMITED, Tokyo (JP)

(21) Appl. No.: 17/773,862

(22) PCT Filed: Dec. 23, 2020
(86) PCT No.: PCT/JP2020/048163

§ 371 Date: May 3, 2022

(30) Foreign Application Priority Data
Jan. 10, 2020 (JP) 2020-003202

(51) Int. Cl. C09D 183/04; C09D 7/20; C09D 5/08

(52) U.S. Cl. CPC C09D 183/04; C09D 7/20; C09D 5/08

(57) ABSTRACT

A curable composition comprising a condensate having an alkyl group having 6 to 30 carbon atoms, wherein the curable composition has at least one peak with a concentration fraction of 250000 or more in a range where the molecular weight in terms of standard polyethylene glycol is 500 or more and 2000 or less in a differential molecular weight distribution curve determined from a chromatogram obtained by GPC chromatography.

### TECHNICAL FIELD

The present invention relates to a curable composition comprising a condensate having an alkyl group having 6 to 30 carbon atoms.

### BACKGROUND ART

In various display devices, optical elements, semiconductor elements, building materials, automobile parts, nanoimprint techniques and the like, adherence of the liquid droplet to a surface of a base material may cause problems such as contamination and corrosion of the base material, and deterioration of performance due to the contamination and corrosion. Thus, in these fields, a surface of a base material is required to have a good water-repellent property and oil-repellent property.

As a composition capable of providing a water-repellent and oil-repellent film, a composition containing organosiloxane as a main component is known. For example, Patent Literature 1 discloses a two-component mixed liquid composition including a precursor (A) which is a group of combination compounds of two or more liquid organosiloxanes composed of a R¹.Si group (R¹ is a monovalent hydrocarbon group) being an organosilicon group and an OR² group (R² is a hydrogen atom or a C₁-C₅ alkyl group or acyl group) being a functional side chain, and a crosslinker (B). Patent Literature 1 discloses that the storage stability of the composition at normal temperature is improved by blocking the crosslinker (B) with a keto-enol tautomeric compound such as malonic acid diester or acetylacetone in advance.

### CITATION LIST

### Patent Literature

Patent Literature 1: Japanese Patent Laid-Open No. 5-230375

### SUMMARY OF INVENTION

### Technical Problem

It is necessary to further improve the storage stability of the composition, and a film formed using the stored composition is required to have a good water-repellent property and oil-repellent property. Good workability during formation of a film using the stored composition is also required.

An object of the present invention is to provide a composition capable of forming a film having a good liquid-repellent property (water-repellent property in particular), and excellent in storage stability and workability during formation of a film using the stored composition.

### Solution to Problem

The present invention is as follows.

[1] A curable composition comprising a condensate having an alkyl group having 6 to 30 carbon atoms, wherein the curable composition has at least one peak with a concentration fraction of 250000 or more in a range where the molecular weight in terms of standard polyethylene glycol is 500 or more and 2000 or less in a differential molecular weight distribution curve determined from a chromatogram obtained by GPC chromatography.
[2] The curable composition according to [1], wherein the curable composition has at least one peak with a concentration fraction of 200000 or more in a range where the molecular weight in terms of standard polyethylene glycol is 500 or more and 800 or less in the differential molecular weight distribution curve.
[3] The curable composition according to [1] or [2], which is a mixed composition of an organosilicon compound (A) represented by formula (a1) and an organosilicon compound (B) represented by formula (b1):

R^{a1}—Si(Xₐ₁)₃ (a1)

wherein R^{a1} represents a hydrocarbon group having 6 to 30 carbon atoms, and X^{a1} represents a hydrolyzable group, and

Si(R^{b1})_{b20}(X^{b1})_{4-b20} (b1)

wherein R^{b1} represents a hydrocarbon group having 1 to 5 carbon atoms, X^{b1} represents a hydrolyzable group, and b20 is 0 or 1.

[4] The curable composition according to [3], wherein water (D) is mixed, and the mass ratio (D/A) of the water (D) to the organosilicon compound (A) is 20 or more.
[5] The curable composition according to any one of [1] to [4], wherein in a chromatogram obtained by GPC chromatography of the curable composition, the ratio (Y/X) of a high-molecular-weight component (Y) having a molecular weight of more than 800 in terms of standard polyethylene glycol to a low-molecular-weight component (X) having a molecular weight of 500 or more and 800 or less in terms of standard polyethylene glycol is 3.0 or less.
[6] The curable composition according to any one of [1] to [5], wherein a compound (C1) represented by formula (c1) is mixed:

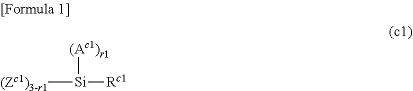

wherein A^{c1} represents a hydroxy group or a hydrolyzable group, a plurality of A^{c1}s, when present, are optionally different from each other, Z^{c1} represents a hydrocarbon group, a trialkylsilyl group-containing molecular chain or a siloxane backbone-containing group, a plurality of Z^{c1}s, when present, are optionally different from each other, and r1 represents an integer of 1 to 3; and

R^{c1} represents a group represented by formula (c11):

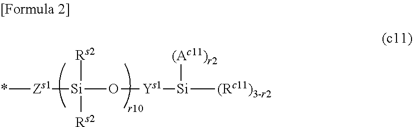

wherein R^{s2}s each independently represent an alkyl group having 1 to 4 carbon atoms;

R^{c11} represents a hydrocarbon group or a trialkylsilyloxy group, hydrogen atoms in the hydrocarbon group or the trialkylsilyloxy group are optionally replaced by fluorine atoms, and a plurality of R^{c11}s, when present, are optionally different from each other;

A^{c11} represents a hydroxy group or a hydrolyzable group, and a plurality of A^{c11}s, when present, are optionally different from each other;

Z^{s1} represents —O— or a divalent hydrocarbon group, and —CH₂— in the divalent hydrocarbon group is optionally replaced by —O—;

Y^{s1} represents a singly bond or —Si(R^{s2})₂—L^{s1}—, L^{s1} represents a divalent hydrocarbon group, and —CH₂— in the divalent hydrocarbon group is optionally replaced by —O—;

r2 represents an integer of 0 to 3;

r10 represents an integer of 1 or more; and

* represents a bond.

[7] The curable composition according to [6], wherein the compound (C1) is a compound represented by formula (c1-I):

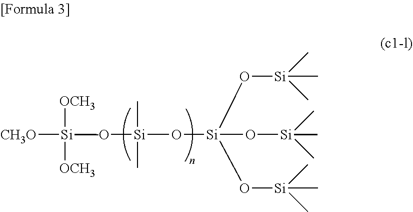

wherein n represents an integer of 1 to 60.

[8] The curable composition according to any one of [1] to [7], wherein a solvent (E) is mixed.
[9] The curable composition according to any one of [1] to [8], wherein a weak acid (G) having a pKa of 1 or more and 5 or less is mixed.
[10] The curable composition according to any one of [1] to [9], for use in formation of a liquid-repellent film.

### Advantageous Effect of Invention

When the curable composition of the present invention is used, it is possible to provide a film having a good liquid-repellent property (water-repellent property in particular). The curable composition of the present invention is excellent in storage stability, and therefore even when a film is formed after storage, the obtained film has an excellent liquid-repellent property (water-repellent property in particular). Even when a film is formed after storage of the curable composition of the present invention, workability during formation of the film is good.

### BRIEF DESCRIPTION OF DRAWINGS

FIG. 1 shows differential molecular weight distribution curves for coating solutions 1, 3 and 5 obtained in Examples 1, 3 and 5.

FIG. 2 shows differential molecular weight distribution curves for coating solutions 2, 4 and 6 obtained in Examples 2, 4 and 6.

FIG. 3 shows a differential molecular weight distribution curve for a coating solution 7 obtained in Example 7.

FIG. 4 shows differential molecular weight distribution curves for coating solutions 14 and 15 obtained in Examples 14 and 15.

FIG. 5 shows differential molecular weight distribution curves for a coating solution 16 obtained in Example 16 and a coating solution 17 obtained in Comparative Example 1.

### DESCRIPTION OF EMBODIMENT

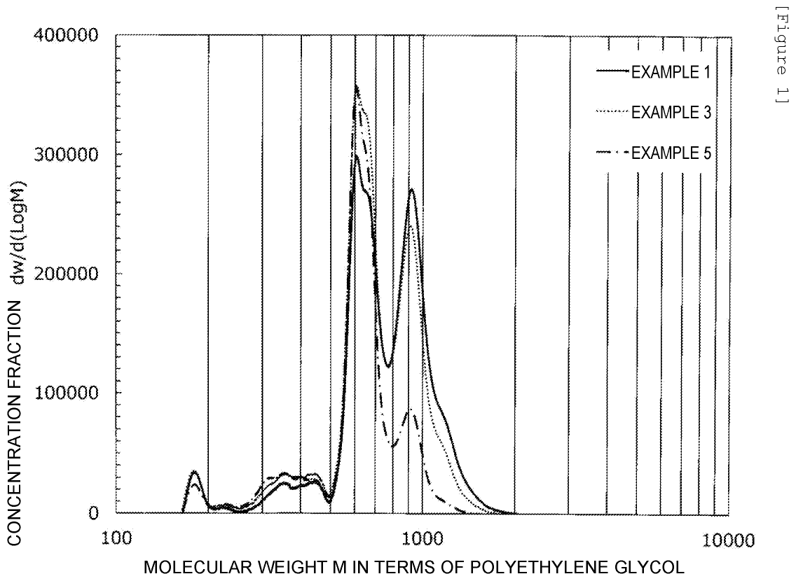

A curable composition of the present invention comprises a condensate having an alkyl group having 6 to 30 carbon atoms, and has at least one peak with a concentration fraction of 250000 or more in a range where the molecular weight in terms of standard polyethylene glycol is 500 or more and 2000 or less in a differential molecular weight distribution curve determined from a chromatogram obtained by GPC chromatography. When the curable composition is used, it is possible to form a film having a good liquid-repellent property (water-repellent property in particular). The curable composition of the present invention is excellent in storage stability, and even when a film is formed after storage, the performance of the film is unlikely to be deteriorated. The curable composition of the present invention is excellent in workability during formation of a film after storage, so that it is easy to form a film. As used herein, the term “peak” means a maximum in a distribution when a differential molecular weight distribution curve determined from a chromatogram obtained by GPC chromatography. For example, in the curve indicated by a solid line in FIG. 1, a maximum is observed at each of molecular weights M in terms of polyethylene glycol of about 600 and about 900, and means a peak.

The curable composition may have two or more peaks with a concentration fraction of 250000 or more in a range where the molecular weight in terms of standard polyethylene glycol is 500 or more and 2000 or less in the differential molecular weight distribution curve. When two or more peaks with a concentration fraction of 250000 or more are present in the above-described range, it is possible to form a film having a better liquid-repellent property (water-repellent property in particular). The number of peaks with a concentration fraction of 250000 or more in the above-described range is preferably 3 or less, for example.

Preferably, the curable composition does not have a peak with a concentration fraction of 250000 or more in a range where the molecular weight in terms of standard polyethylene glycol is more than 2000 in the differential molecular weight distribution curve. When the curable composition does not have a peak with a concentration fraction of 250000 or more in the above-described range, it is possible to form a film having a good liquid-repellent property (water-repellent property in particular), it is possible to form a film having a good liquid-repellent property (water-repellent property in particular) even after storage, and workability during formation of the film is improved.

The number of carbon atoms in the alkyl group is preferably 7 or more, more preferably 8 or more, still more preferably 10 or more, and preferably 20 or less, more preferably 18 or less, still more preferably 12 or less.

The alkyl group may be linear or branched, and is preferably linear. The alkyl group is preferably a hexyl group, a heptyl group, an octyl group, a nonyl group, a decyl group, an undecyl group, a dodecyl group, a tetradecyl group, a hexadecyl group or an octadecyl group, more preferably an octyl group, a decyl group, a dodecyl group, a tetradecyl group, a hexadecyl group or an octadecyl group, still more preferably an octyl group, a decyl group or a dodecyl group.

The condensate may have an alkyl group having 6 to 30 carbon atoms, and for example, a condensate of an organosilicon compound is preferable. The organosilicon compound will be described later.

The curable composition of the present invention is applied to a base material, and then left to stand at normal temperature and normal humidity to perform curing, thereby forming a film. The film has a liquid-repellent property. Therefore, the curable composition of the present invention can be used for forming a liquid-repellent film.

The differential molecular weight distribution curve is a curve showing a concentration fraction for each molecular weight (M), and the molecular weight (M) is a value which is determined by calculating a dissolution time in a chromatogram obtained by GPC chromatography in terms of the molecular weight of polyethylene glycol (standard product) from a calibration curve. In the chromatogram obtained by GPC chromatography, a curve A showing a ratio of a peak intensity at a predetermined dissolution time (i.e. molecular weight (M)) to the total peak area is drawn, and the slope of the curve A at the predetermined molecular weight (M) (i.e. differential value, where the abscissa is set to a logarithm of the molecular weight (M) when the slope is determined) is defined as a concentration fraction at the molecular weight (M).

It is preferable that the curable composition have at least one peak with a concentration fraction of 200000 or more in a range where the molecular weight in terms of standard polyethylene glycol is 500 or more and 800 or less in the differential molecular weight distribution curve. When one or more peaks with a concentration fraction of 200000 or more are present in the above-described range, the storage stability of the curable composition can be further improved. Even after storage, the curable composition is excellent in workability during formation of a film. The number of peaks with the concentration fraction being 200000 or more is preferably 2 or less, for example.

In the curable composition, the ratio (Y/X) of a high-molecular-weight component (Y) having a molecular weight of more than 800 in terms of standard polyethylene glycol to a low-molecular-weight component (X) having a molecular weight of 500 or more and 800 or less in terms of standard polyethylene glycol is preferably 3.0 or less in a chromatogram obtained by GPC chromatography. When the ratio (Y/X) is 3.0 or less, the storage stability of the curable composition can be further improved. Even after storage, the curable composition is excellent in workability during formation of a film. The ratio (Y/X) is more preferably 2.8 or less, still more preferably 2.0 or less, furthermore preferably 1.5 or less, particularly preferably 1.0 or less. The ratio (Y/X) is preferably small. The lower limit of the ratio (Y/X) may be, for example, 0.1 or more.

The curable composition is preferably a mixed composition of an organosilicon compound (A) represented by the following formula (a1) and an organosilicon compound (B) represented by the following formula (b1).

R^{a1}—Si(X^{a1})₃ (a1)

In formula (a1), R^{a1} represents a hydrocarbon group having 6 to 30 carbon atoms, and X^{a1} represents a hydrolyzable group.

Si(R^{b1})_{b20}(X^{b1})_{4-b20} (b1)

In formula (b1), R^{b1} represents a hydrocarbon group having 1 to 5 carbon atoms, X^{b1} represents a hydrolyzable group, and b20 is 0 or 1.

### [Organosilicon Compound (A)]

In the above formula (a1), the number of carbon atoms in the hydrocarbon group represented by R^{a1} is preferably 7 or more, more preferably 8 or more, still more preferably 10 or more, and preferably 20 or less, more preferably 18 or less, still more preferably 12 or less.

The hydrocarbon group represented by R^{a1} is preferably a saturated hydrocarbon group, more preferably a linear or branched alkyl group, still more preferably a linear alkyl group. The alkyl group is preferably a hexyl group, a heptyl group, an octyl group, a nonyl group, a decyl group, an undecyl group, a dodecyl group, a tetradecyl group, a hexadecyl group or an octadecyl group, more preferably an octyl group, a decyl group, a dodecyl group, a tetradecyl group, a hexadecyl group or an octadecyl group, still more preferably an octyl group, a decyl group or a dodecyl group.

Examples of the hydrolyzable group represented by X^{a1} in the above formula (a1) include groups which give a hydroxy group (silanol group) when hydrolyzed, and alkoxy groups having 1 to 6 carbon atoms, a cyano group, an acetoxy group, a chlorine atom, an isocyanate group and the like are preferable. Three X^{a1}s may be the same or different, and are preferably the same. X³¹ is preferably an alkoxy group or a cyano group having 1 to 6 (more preferably 1 to 4, still more preferably 1 or 2) carbon atoms, more preferably an alkoxy group having 1 to 6 (more preferably 1 to 4, still more preferably 1 or 2) carbon atoms, and it is still more preferable that all X^{a1} is be alkoxy groups having 1 to 6 (more preferably 1 to 4, still more preferably 1 or 2) carbon atoms.

The organosilicon compound (A) is preferably one in which R^{a1} is a linear alkyl group having 6 to 18 (more preferably 8 to 18, still more preferably 8 to 12) carbon atoms, and all X^{a1}s are the same, and are alkoxy groups having 1 to 6 (more preferably 1 to 4, still more preferably 1 or 2) carbon atoms.

Specific examples of the organosilicon compound (A) include hexyltrimethoxysilane, hexyltriethoxysilane, heptyltrimethoxysilane, heptyltriethoxysilane, octyltrimethoxysilane, octyltriethoxysilane, nonyltrimethoxysilane, nonyltriethoxysilane, decyltrimethoxysilane, decyltriethoxysilane, undecyltrimethoxysilane, undecyltriethoxysilane, dodecyltrimethoxysilane, dodecyltriethoxysilane, tridecyltrimethoxysilane, tridecyltriethoxysilane, tetradecyltrimethoxysilane, tetradecyltriethoxysilane, pentadecyltrimethoxysilane, pentadecyltriethoxysilane, hexadecyltrimethoxysilane, hexadecyltriethoxysilane, heptadecyltrimethoxysilane, heptadecyltriethoxysilane, octadecyltrimethoxysilane and octadecyltriethoxysilane, and octyltrimethoxysilane, octyltriethoxysilane, decyltrimethoxysilane, decyltriethoxysilane, dodecyltrimethoxysilane, dodecyltriethoxysilane, tetradecyltrimethoxysilane, tetradecyltriethoxysilane, hexadecyltrimethoxysilane, hexadecyltriethoxysilane, octadecyltrimethoxysilane and octadecyltriethoxysilane are preferable, with octyltrimethoxysilane, octyltriethoxysilane, decyltrimethoxysilane, decyltriethoxysilane, dodecyltrimethoxysilane and dodecyltriethoxysilane being more preferable.

The organosilicon compounds (A) may be used alone, or used in combination of two or more thereof.

When the total amount of the curable composition is 100 mass %, the amount of the organosilicon compound (A) is preferably 0.1 mass % or more, more preferably 0.2 mass % or more, still more preferably 0.3 mass % or more, and preferably 3 mass % or less, more preferably 2 mass % or less, still more preferably 1 mass % or less.

### [Organosilicon Compound (B)]

In the above formula (b1), the hydrocarbon group represented by R^{b1} is preferably a saturated hydrocarbon group, more preferably a linear or branched alkyl group, still more preferably a linear alkyl group. The alkyl group is particularly preferably a methyl group, an ethyl group or a propyl group.

In the above formula (b1), b20 is preferably 0.

Examples of the hydrolyzable group represented by X^{b1} in the above formula (b1) include groups similar to the hydrolyzable group represented by X^{a1}, and alkoxy groups having 1 to 6 carbon atoms, a cyano group, an acetoxy group, a chlorine atom, an isocyanate group and the like are preferable. A plurality of X^{b1}s may be the same or different, and are preferably the same. X^{b1} is preferably an alkoxy group having 1 to 6 (more preferably 1 to 4) carbon atoms, or an isocyanate group, more preferably an alkoxy group having 1 to 6 (more preferably 1 to 4) carbon atoms, and it is still more preferable that all X^{b1}s be alkoxy groups having 1 to 6 (more preferably 1 to 4) carbon atoms.

The organosilicon compound (B) is preferably one in which b20 is 0, and X^{b1} is an alkoxy group having 1 to 6 (more preferably 1 to 4) carbon atoms.

Specific examples of the organosilicon compound (B) include tetramethoxysilane, tetraethoxysilane (tetraethyl orthosilicate), tetrapropoxysilane, tetrabutoxysilane, methyltrimethoxysilane, methyltriethoxysilane, methyltripropoxysilane and methyltributoxysilane, and tetramethoxysilane and tetraethoxysilane are preferable.

The organosilicon compounds (B) may be used alone, or used in combination of two or more thereof.

When the total amount of the curable composition is 100 mass %, the amount of the organosilicon compound (B) is preferably 0.1 mass % or more, more preferably 0.2 mass % or more, still more preferably 0.3 mass % or more, and preferably 3 mass % or less, more preferably 2 mass % or less, still more preferably 1 mass % or less.

When the total amount of the curable composition is 100 mass %, the total amount of the organosilicon compound (A) and the organosilicon compound (B) is preferably 0.2 mass % or more, more preferably 0.3 mass % or more, still more preferably 0.4 mass % or more, particularly preferably 0.6 mass % or more, and preferably 6 mass % or less, more preferably 4 mass % or less, still more preferably 2 mass % or less, furthermore preferably 1.5 mass % or less, particularly preferably 1 mass % or less.

From the viewpoint of improving the liquid-repellent property (slip drop property in particular), the molar ratio (B/A) of the organosilicon compound (B) to the organosilicon compound (A) is preferably 0.01 to 48. The molar ratio (B/A) is more preferably 0.1 or more, still more preferably 0.3 or more, furthermore preferably 0.5 or more, particularly preferably 0.8 or more. The molar ratio (B/A) is more preferably 40 or less, still more preferably 25 or less, furthermore preferably 10 or less, furthermore preferably 8 or less, particularly preferably 4 or less, most preferably 1 or less.

The molar ratio (B/A) of the organosilicon compound (B) to the organosilicon compound (A) can be adjusted during preparation of the curable composition. The molar ratio (B/A) of the organosilicon compound (B) to the organosilicon compound (A) may be calculated from the result of analysis of the curable composition. Where the range of the molar ratios, the amounts or the mass ratios of the components is described herein, the range can be adjusted during preparation of the curable composition like the above.

It is preferable that in the curable composition, a compound (C1) represented by formula (c1) be mixed. By mixing the compound (C1), workability during formation of a film is improved. In addition, the concentration fraction in the differential molecular weight distribution is easily controlled to be a predetermined value.

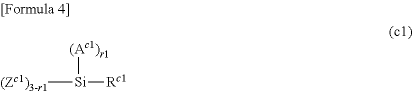

In formula (c1), A^{c1} represents a hydroxy group or a hydrolyzable group, a plurality of A^{c1}s, when present, are optionally different from each other, Z^{c1} represents a hydrocarbon group, a trialkylsilyl group-containing molecular chain or a siloxane backbone-containing group, a plurality of Z^{c1}s, when present, are optionally different from each other, r1 represents an integer of 1 to 3, and R^{c1} represents a group represented by formula (c11).

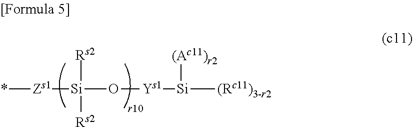

In formula (c11), R^{s2}s each independently represent an alkyl group having 1 to 4 carbon atoms, R^{c11} represents a hydrocarbon group or a trialkylsilyloxy group, hydrogen atoms in the hydrocarbon group or the trialkylsilyloxy group are optionally replaced by fluorine atoms, a plurality of R^{c11}s, when present, are optionally different from each other, A^{c11} represents a hydroxy group or a hydrolyzable group, a plurality of A^{c11}s, when present, are optionally different from each other, Z^{s1} represents —O— or a divalent hydrocarbon group, —CH₂— in the divalent hydrocarbon group is optionally replaced by —O—, Y^{s1} represents a single bond or —Si(R^{s2})₂-L^{s1}-, L^{s1} represents a divalent hydrocarbon group, —CH₂— in the divalent hydrocarbon group is optionally replaced by —O—, r2 represents an integer of 0 to 3, r10 represents an integer of 1 or more, and * represents a bond.

The compound (C1) is a compound which suppresses curing of the film, and the compound (C1) has an action of suppressing condensation reaction between hydrolysable groups remaining in the organosilicon compound (A) and the organosilicon compound (B) after film formation. When film formation is performed using a curable composition in which the organosilicon compound (A) and the organosilicon compound (B) are mixed, the obtained film may continue to cure after film formation, and when the film is excessively cured, the liquid-repellent property (water-repellent property in particular) may be deteriorated. Thus, by mixing the compound (C1) in the curable composition of the present invention, excessive curing of the obtained film can be suppressed, and deterioration of the liquid-repellent property (water-repellent property in particular) can be suppressed.

First, the moiety represented by the following formula (s2) (hereinafter, sometimes referred to as a molecular chain (s2)) in the group represented by the above formula (c11) will be described.

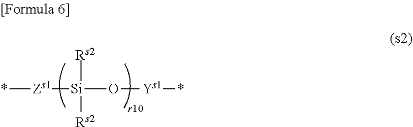

In the molecular chain (s2), the number of carbon atoms in the alkyl group represented by R^{s2} is preferably 1 to 4, more preferably 1 to 3, still more preferably 1 to 2. Examples of the alkyl group represented by R^{s2} is preferably a methyl group, an ethyl group, a propyl group and a butyl group, and a methyl group or an ethyl group is preferable, with a methyl group being particularly preferable.

In the molecular chain (s2), r10 is preferably an integer of 1 to 100, more preferably an integer of 1 to 80, still more preferably an integer of 1 to 60, particularly preferably an integer of 1 to 50, most preferably an integer of 1 to 30.

In the molecular chain (s2), the number of carbon atoms in the divalent hydrocarbon group represented by Z^{s1} or L^{s1} is preferably 1 to 10, more preferably 1 to 6, still more preferably 1 to 4. The divalent hydrocarbon group is preferably chainlike, and may be linear or branched when the divalent hydrocarbon group is chainlike. The divalent hydrocarbon group is preferably a divalent aliphatic hydrocarbon group, which is preferably an alkanediyl group. Examples of the divalent hydrocarbon group include a methylene group, an ethylene group, a propylene group and a butylene group.

Further, some of —CH₂-s in the divalent hydrocarbon group are optionally replaced by —O—. In this case, both two consecutive —CH₂-s are not replaced by —O—, and —CH₂-adjacent to the Si atom is not replaced by —O—. When two or more —CH₂-s are replaced by —O—, the number of carbon atoms between —O— and —O— is preferably 2 to 4, more preferably 2 or 3. As the group in which a part of the divalent hydrocarbon group is replaced by —O—, specifically, groups having a (poly)ethylene glycol unit, groups having a (poly)propylene glycol unit, and the like can be exemplified.

In the molecular chain (s2), Z^{s1} is preferably —O— or a divalent aliphatic hydrocarbon group, more preferably —O—. In the molecular chain (s2), Y^{s1} is preferably a single bond. Preferably, Z^{s1} is —O— and Y^{s1} is a single bond in the molecular chain (s2), i.e. the molecular chain (s2) consists only of repeated dialkylsilyloxy groups.

Examples of the molecular chain (s2) include molecular chains represented by the following formulae. In the formula, r21 represents an integer of 1 or more, represents a bond to a silicon atom. r21 is in the same numerical range as that for r10 above, and the same applies to the preferred range.

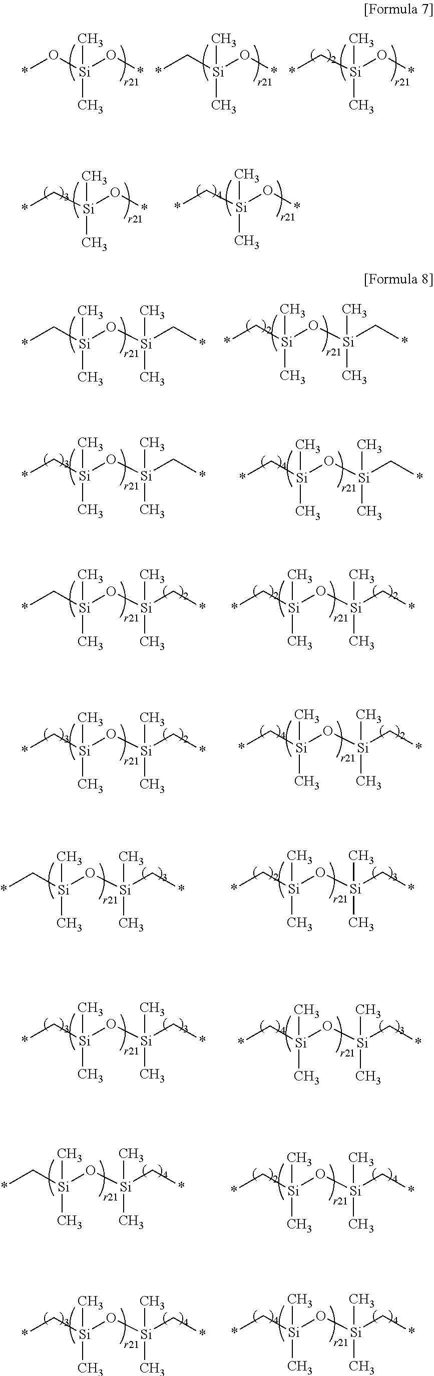

Next, moieties other than the molecular chain (s2) in the group represented by the above formula (c11) will be described. In formula (c11), R^{c11} represents a hydrocarbon group or a trialkylsilyloxy group, and hydrogen atoms in the hydrocarbon group or the trialkylsilyloxy group are optionally replaced by fluorine atoms. The number of the replacing fluorine atoms is preferably 1 or more, more preferably 3 or more, and preferably equal to or less than 2×A+1 where A is the number of carbon atoms.

When R^{c11} is a hydrocarbon group, the number of carbon atoms in the group is preferably 1 to 4, more preferably 1 to 3, still more preferably 1 or 2. When R^{c11} is a hydrocarbon group, an aliphatic hydrocarbon group is preferable, and an alkyl group is more preferable. Examples of the alkyl group include a methyl group, an ethyl group, a propyl group and a butyl group.

When R^{c11} is a trialkylsilyloxy group, the number of carbon atoms in the alkyl group forming the trialkylsilyloxy group is preferably 1 to 4, more preferably 1 to 3, still more preferably 1 or 2. Examples of the alkyl group include a methyl group, an ethyl group, a propyl group and a butyl group. The three alkyl groups forming the trialkylsilyloxy group may be the same or different, and are preferably the same. The trialkylsilyloxy group means a group in which an oxygen atom is bonded to a silicon atom of a trialkylsilyl group.

In formula (c11), A^{c11} represents a hydroxy group or a hydrolyzable group. The hydrolyzable group may be a group which gives a hydroxy group (silanol group) when hydrolyzed, and preferred examples thereof include alkoxy groups having 1 to 4 carbon atoms, such as a methoxy group, an ethoxy group, a propoxy group and a butoxy group; an acetoxy group; a chlorine atom; and an isocyanate group. A^{c11} is more preferably an alkoxy group having 1 to 4 carbon atoms, still more preferably an alkoxy group having 1 or 2 carbon atoms.

R^{c1} represented by the above formula (c11) is preferably a group represented by the following formula (c11-1) or formula (c11-2).

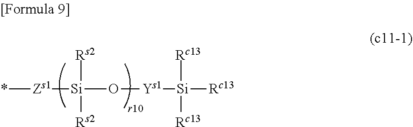

In formula (c11-1), Z31, R^{s2}, Y^{s1} and r10 have the same meanings as described above, R^{c13}s each independently represent a hydrocarbon group or a trialkylsilyloxy group, hydrogen atoms in the hydrocarbon group or the trialkylsilyloxy group are optionally replaced by fluorine atoms, and * represents a bond to a silicon atom.

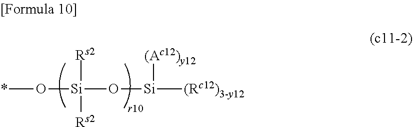

In formula (c11-2), R³² and r10 have the same meanings as those described above, A^{c12} represents a hydroxy group or a hydrolyzable group, a plurality of A^{c32}s, when present, are optionally different from each other, R^{c12} represents a hydrocarbon group, a plurality of R^{c12}s, when present, are optionally different from each other, and y12 represents an integer of 1 to 3. * represents a bond to a silicon atom.

First, the group represented by formula (c11-1) will be described. Examples of the hydrocarbon group represented by R^{c13} in formula (c11-1) include those similar to the hydrocarbon groups described for R^{c11} above, and the hydrocarbon group is preferably an alkyl group having 1 to 4 carbon atoms, more preferably an alkyl group having 1 to 3 carbon atoms, still more preferably an alkyl group having 1 or 2 carbon atoms. In particular, when all R^{c13}s are hydrocarbon groups, R^{c13} is preferably an alkyl group. The three R^{c13}s may be the same or different, and are preferably the same. When all R^{c13}s are hydrocarbon groups, the total number of carbon atoms of the three R^{c13}s is preferably 9 or less, more preferably 6 or less, still more preferably 4 or less. Preferably at least one, more preferably at least two, particularly preferably all of the three R^{c13}s are methyl groups.

Examples of the trialkylsilyloxy group represented by R^{c13} in formula (c11-1) include those similar to the trialkylsilyloxy groups described for R-11 above, and the same applies to the preferred range. In formula (c11-1), at least one of the R^{c13}s may be a trialkylsilyloxy group, and it is also preferable that all of the R^{c13}s be trialkylsilyloxy groups.

The group represented by formula (c11-1) is more preferably a group of the following formula (s3-1), still more preferably a group of the following formula (s3-1-1). It is also preferable that the group represented by formula (c11-1) be a group represented by the following formula (s3-2), and a group represented by the following formula (s3-2-1) is more preferable.

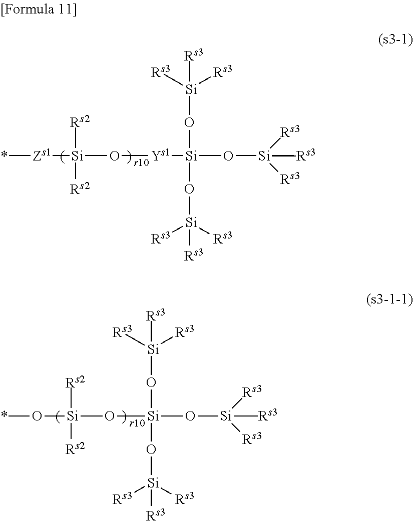

In formulae (s3-1) and (s3-1-1), Z^{s1}, R^{s2}, Y^{s1} and r10 have the same meanings as described above. R^{s3} represents an alkyl group having 1 to 4 carbon atoms. * represents a bond to a silicon atom.

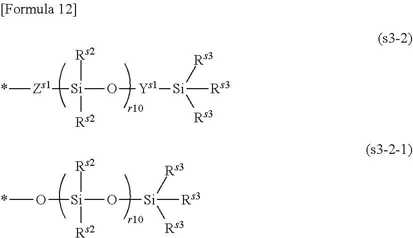

In formulae (s3-2) and (s3-2-1), Z^{s1}, R^{s2}, Y^{s1}, R^{s3} and r10 have the same meanings as described above. * represents a bond to a silicon atom.

The number of carbon atoms in the alkyl group represented by R^{s3} is preferably 1 to 3, more preferably 1 or 2. In formulae (s3-1), (s3-1-1), (s3-2) and (s3-2-1), the total number of carbon atoms in R^{s3}s in —Si(R^{s3})₃ is preferably 9 or less, more preferably 6 or less, still more preferably 4 or less. Further, preferably at least one, preferably at least two, particularly preferably all of the three R^{s3}s in —Si(R^{s3})₃ are methyl groups.

Examples of the group represented by formula (c11-1) include groups represented by formula (s3-I). In formula (s3-I), combinations of Z^{s10}, R^{s20}, n10, Y^{s10} and R^{s10} are preferably those shown in the tables below.

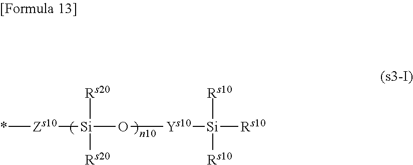

TABLE 1

| | Z^{s10} | R^{s20} | n10 | y^{s10} | R^{s10} |
|---|---|---|---|---|---|
| (s3-I-1) | *—O—* | CH₃—* | 1~60 | — | (CH₃)₃SiO—* |
| (s3-I-2) | *—O—* | CH₃—* | 1~60 | *—Si(CH₃)₂—CH₂—* | (CH₃)₃SiO—* |
| (s3-I-3) | *—O—* | CH₃—* | 1~60 | *—Si(CH₃)₂—(CH₂)₂—* | (CH₃)₃SiO—* |
| (s3-I-4) | *—O—* | CH₃—* | 1~60 | *—Si(CH₃)₂—(CH₂)₃—* | (CH₃)₃SiO—* |
| (s3-I-5) | *—O—* | CH₃—* | 1~60 | *—Si(CH₃)₂—(CH₂)₄—* | (CH₃)₃SiO—* |
| (s3-I-6) | *—CH₂—* | CH₃—* | 1~60 | — | (CH₃)₃SiO—* |
| (s3-I-7) | *—CH₂—* | CH₃—* | 1~60 | *—Si(CH₃)₂—CH₂—* | (CH₃)₃SiO—* |
| (s3-I-8) | *—CH₂—* | CH₃—* | 1~60 | *—Si(CH₃)₂—(CH₂)₂—* | (CH₃)₃SiO—* |
| (s3-I-9) | *—CH₂—* | CH₃—* | 1~60 | *—Si(CH₃)₂—(CH₂)₃—* | (CH₃)₃SiO—* |
| (s3-I-10) | *—CH₂—* | CH₃—* | 1~60 | *—Si(CH₃)₂—(CH₂)₄—* | (CH₃)₃SiO—* |
| (s3-I-11) | *—(CH₂)₂—* | CH₃—* | 1~60 | — | (CH₃)₃SiO—* |
| (s3-I-12) | *—(CH₂)₂—* | CH₃—* | 1~60 | *—Si(CH₃)₂—CH₂—* | (CH₃)₃SiO—* |
| (s3-I-13) | *—(CH₂)₂—* | CH₃—* | 1~60 | *—Si(CH₃)₂—(CH₂)₂—* | (CH₃)₃SiO—* |
| (s3-I-14) | *—(CH₂)₂—* | CH₃—* | 1~60 | *—Si(CH₃)₂—(CH₂)₃—* | (CH₃)₃SiO—* |
| (s3-I-15) | *—(CH₂)₂—* | CH₃—* | 1~60 | *—Si(CH₃)₂—(CH₂)₄—* | (CH₃)₃SiO—* |
| (s3-I-16) | *—(CH₂)₃—* | CH₃—* | 1~60 | — | (CH₃)₃SiO—* |
| (s3-I-17) | *—(CH₂)₃—* | CH₃—* | 1~60 | *—Si(CH₃)₂—CH₂—* | (CH₃)₃SiO—* |
| (s3-I-18) | *—(CH₂)₃—* | CH₃—* | 1~60 | *—Si(CH₃)₂—(CH₂)₂—* | (CH₃)₃SiO—* |
| (s3-I-19) | *—(CH₂)₃—* | CH₃—* | 1~60 | *—Si(CH₃)₂—(CH₂)₃—* | (CH₃)₃SiO—* |
| (s3-I-20) | *—(CH₂)₃—* | CH₃—* | 1~60 | *—Si(CH₃)₂—(CH₂)₄—* | (CH₃)₃SiO—* |
| (s3-I-21) | *—(CH₂)₄—* | CH₃—* | 1~60 | — | (CH₃)₃SiO—* |
| (s3-I-22) | *—(CH₂)₄—* | CH₃—* | 1~60 | *—Si(CH₃)₂—CH₂—* | (CH₃)₃SiO—* |
| (s3-I-23) | *—(CH₂)₄—* | CH₃—* | 1~60 | *—Si(CH₃)₂—(CH₂)₂—* | (CH₃)₃SiO—* |
| (s3-I-24) | *—(CH₂)₄—* | CH₃—* | 1~60 | *—Si(CH₃)₂—(CH₂)₃—* | (CH₃)₃SiO—* |
| (s3-I-25) | *—(CH₂)₄—* | CH₃—* | 1~60 | *—Si(CH₃)₂—(CH₂)₄—* | (CH₃)₃SiO—* |

TABLE 2

| | Z^{s10} | R^{s20} | n10 | y^{s10} | R^{s10} |
|---|---|---|---|---|---|
| (s3-I-26) | *—O—* | CH₃—* | 1~60 | — | CH₃—* |
| (s3-I-27) | *—O—* | CH₃—* | 1~60 | *—Si(CH₃)₂—CH₂—* | CH₃—* |
| (s3-I-28) | *—O—* | CH₃—* | 1~60 | *—Si(CH₃)₂—(CH₂)₂—* | CH₃—* |
| (s3-I-29) | *—O—* | CH₃—* | 1~60 | *—Si(CH₃)₂—(CH₂)₃—* | CH₃—* |
| (s3-I-30) | *—O—* | CH₃—* | 1~60 | *—Si(CH₃)₂—(CH₂)₄—* | CH₃—* |
| (s3-I-31) | *—CH₂—* | CH₃—* | 1~60 | — | CH₃—* |
| (s3-I-32) | *—CH₂—* | CH₃—* | 1~60 | *—Si(CH₃)₂—CH₂—* | CH₃—* |
| (s3-I-33) | *—CH₂—* | CH₃—* | 1~60 | *—Si(CH₃)₂—(CH₂)₂—* | CH₃—* |
| (s3-I-34) | *—CH₂—* | CH₃—* | 1~60 | *—Si(CH₃)₂—(CH₂)₃—* | CH₃—* |
| (s3-I-35) | *—CH₂—* | CH₃—* | 1~60 | *—Si(CH₃)₂—(CH₂)₄—* | CH₃—* |
| (s3-I-36) | *—(CH₂)₂—* | CH₃—* | 1~60 | — | CH₃—* |
| (s3-I-37) | *—(CH₂)₂—* | CH₃—* | 1~60 | *—Si(CH₃)₂—CH₂—* | CH₃—* |
| (s3-I-38) | *—(CH₂)₂—* | CH₃—* | 1~60 | *—Si(CH₃)₂—(CH₂)₂—* | CH₃—* |
| (s3-I-39) | *—(CH₂)₂—* | CH₃—* | 1~60 | *—Si(CH₃)₂—(CH₂)₃—* | CH₃—* |
| (s3-I-40) | *—(CH₂)₂—* | CH₃—* | 1~60 | *—Si(CH₃)₂—(CH₂)₄—* | CH₃—* |
| (s3-I-41) | *—(CH₂)₃—* | CH₃—* | 1~60 | — | CH₃—* |
| (s3-I-42) | *—(CH₂)₃—* | CH₃—* | 1~60 | *—Si(CH₃)₂—CH₂—* | CH₃—* |
| (s3-I-43) | *—(CH₂)₃—* | CH₃—* | 1~60 | *—Si(CH₃)₂—(CH₂)₂—* | CH₃—* |
| (s3-I-44) | *—(CH₂)₃—* | CH₃—* | 1~60 | *—Si(CH₃)₂—(CH₂)₃—* | CH₃—* |
| (s3-I-45) | *—(CH₂)₃—* | CH₃—* | 1~60 | *—Si(CH₃)₂—(CH₂)₄—* | CH₃—* |
| (s3-I-46) | *—(CH₂)₄—* | CH₃—* | 1~60 | — | CH₃—* |
| (s3-I-47) | *—(CH₂)₄—* | CH₃—* | 1~60 | *—Si(CH₃)₂—CH₂—* | CH₃—* |
| (s3-I-48) | *—(CH₂)₄—* | CH₃—* | 1~60 | *—Si(CH₃)₂—(CH₂)₂—* | CH₃—* |
| (s3-I-49) | *—(CH₂)₄—* | CH₃—* | 1~60 | *—Si(CH₃)₂—(CH₂)₃—* | CH₃—* |
| (s3-I-50) | *—(CH₂)₄—* | CH₃—* | 1~60 | *—Si(CH₃)₂—(CH₂)₄—* | CH₃—* |

n10 shown in Tables 1 and 2 above is preferably an integer of 1 to 30.

Next, the group represented by formula (c11-2) will be described. In formula (c11-2), A^{c12} represents a hydroxy group or a hydrolyzable group, and the hydrolyzable group may be a group which gives a hydroxy group (silanol group) when hydrolyzed, and preferred examples thereof include alkoxy groups having 1 to 4 carbon atoms, such as a methoxy group, an ethoxy group, a propoxy group and a butoxy group; an acetoxy group; a chlorine atom; and an isocyanate group. A^{c12} is preferably an alkoxy group having 1 to 4 carbon atoms or a hydroxy group, more preferably an alkoxy group having 1 or 2 carbon atoms or a hydroxy group. A plurality of A^{c12}s, when present, may be the same or different, and are preferably the same.

Examples of the hydrocarbon group represented by R^{c12} in formula (c11-2) include those similar to the hydrocarbon groups described for R^{c11} above, and the hydrocarbon group is preferably an alkyl group having 1 to 4 carbon atoms, more preferably a methyl group or an ethyl group, still more preferably a methyl group. A plurality of R^{c12}s, when present, may be the same or different, and are preferably the same.

y12 is preferably 1 or 3.

Examples of the group represented by formula (c11-2) include groups represented by formula (s3-II). In formula (s3-II), combinations of A^{c0}, R^{s22}, n20, y0 and R^{c0} are preferably those shown in the tables below.

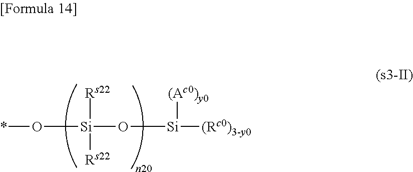

TABLE 3

| | A^{c0} | R^{s20} | n20 | y0 | R^{c0} |
|---|---|---|---|---|---|
| (s3-II-1) | C₂H₅O—* | CH₃—* | 1~60 | 1 | CH₃—* |
| (s3-II-2) | CH₃O—* | CH₃—* | 1~60 | 1 | CH₃—* |
| (s3-II-3) | HO—* | CH₃—* | 1~60 | 1 | CH₃—* |
| (s3-II-4) | C₂H₅O—* | CH₃—* | 1~60 | 1 | C₂H₅—* |
| (s3-II-5) | CH₃O—* | CH₃—* | 1~60 | 1 | C₂H₅—* |
| (s3-II-6) | HO—* | CH₃—* | 1~60 | 1 | C₂H₅—* |
| (s3-II-7) | C₂H₅O—* | CH₃—* | 1~60 | 2 | CH₃—* |
| (s3-II-8) | CH₃O—* | CH₃—* | 1~60 | 2 | CH₃—* |
| (s3-II-9) | HO—* | CH₃—* | 1~60 | 2 | CH₃—* |
| (s3-II-10) | C₂H₅O—* | CH₃—* | 1~60 | 2 | C₂H₅—* |
| (s3-II-11) | CH₃O—* | CH₃—* | 1~60 | 2 | C₂H₅—* |
| (s3-II-12) | HO—* | CH₃—* | 1~60 | 2 | C₂H₅—* |
| (s3-II-13) | C₂H₅O—* | CH₃—* | 1~60 | 3 | — |
| (s3-II-14) | CH₃O—* | CH₃—* | 1~60 | 3 | — |
| (s3-II-15) | HO—* | CH₃—* | 1~60 | 3 | — |

n20 shown in Table 3 above is preferably an integer of 1 to 30.

Next, formula (c1) will be described. A^{c1} in formula (c1) represents a hydroxy group or a hydrolyzable group, and the hydrolyzable group may be a group which gives a hydroxy group (silanol group) when hydrolyzed, and preferred examples thereof include alkoxy groups having 1 to 4 carbon atoms, such as a methoxy group, an ethoxy group, a propoxy group and a butoxy group; an acetoxy group; a chlorine atom; and an isocyanate group. A^{c1} is preferably an alkoxy group having 1 to 4 carbon atoms, more preferably an alkoxy group having 1 or 2 carbon atoms. A plurality of A^{c1}s, when present, may be the same or different, and are preferably the same.

Z^{c1} in formula (c1) represents a hydrocarbon group, a trialkylsilyl group-containing molecular chain or a siloxane backbone-containing group.

When Z^{c1} is a hydrocarbon group, the number of carbon atoms thereof is preferably 1 to 4, more preferably 1 to 3, still more preferably 1 or 2. When Z^{c1} is a hydrocarbon group, an aliphatic hydrocarbon group is preferable, and an alkyl group is more preferable. Examples of the alkyl group include a methyl group, an ethyl group, a propyl group and a butyl group, and a methyl group or an ethyl group is still more preferable, with a methyl group being particularly preferable.

The trialkylsilyl group-containing molecular chain means a monovalent group having a structure in which a trialkylsilyl-containing group is bonded to an end of the molecular chain. When Z^{c1} is a trialkylsilyl group-containing molecular chain, a group of the above formula (c11-1) is preferable where when all R^{c13}s are hydrocarbon groups, the R^{c13}s are alkyl groups.

When Z^{c1} is a siloxane backbone-containing group, the siloxane backbone-containing group is preferably a monovalent group containing a siloxane unit (Si—O—) and consisting of atoms whose number is smaller than the number of atoms forming R^{c1}. This makes the siloxane backbone-containing group smaller in length or three-dimensional extent (bulkiness) than R^{c1}. The siloxane backbone-containing group may contain a divalent hydrocarbon group.

The siloxane backbone-containing group is preferably a group of the following formula (s4).

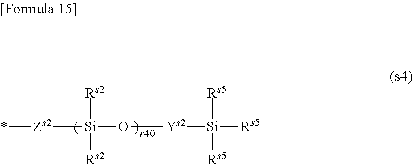

In formula (s4), R^{s2} has the same meaning as that described above, and R^{s2}s each independently represent an alkyl group having 1 to 4 carbon atoms.

R^{s5} represents a hydrocarbon group or a hydroxy group, —CH₂— in the hydrocarbon group is optionally replaced by —O—, and hydrogen atoms in the hydrocarbon group are optionally replaced by fluorine atoms.

Z^{s2} represents —O— or a divalent hydrocarbon group, and —CH₂— in the divalent hydrocarbon group is optionally replaced by —O—.

Y^{s2} represents a single bond or —Si(Rₛ₂)₂—L^{s2}—. L^{s2} represents a divalent hydrocarbon group, and —CH₂— in the divalent hydrocarbon group is optionally replaced by —O—.

r40 represents an integer of 0 to 5. * represents a bond to a silicon atom.

Examples of the hydrocarbon group represented by R^{s5} in formula (s4) include groups similar to the hydrocarbon groups described for R^{c11} above, and aliphatic hydrocarbon groups are preferable, with alkyl groups being more preferable. The number of carbon atoms is preferably 1 to 4, more preferably 1 to 3, still more preferably 1 or 2.

Examples of the divalent hydrocarbon group represented by Z^{s2} or L^{s2} include groups similar to the divalent hydrocarbon groups represented by Z^{s1}, and the number of carbon atoms is preferably 1 to 10, more preferably 1 to 6, still more preferably 1 to 4. The divalent hydrocarbon group represented by Z^{s2} or L^{s2} is preferably a divalent aliphatic hydrocarbon group, more preferably a linear or branched alkanediyl group.

r40 is preferably an integer of 1 to 5, more preferably an integer of 1 to 3.

The total number of atoms in the siloxane backbone-containing group is preferably 100 or less, more preferably 50 or less, still more preferably 30 or less, and preferably 10 or more. The difference between the number of atoms in R^{c1} and the number of atoms in the siloxane backbone-containing group is 10 or more, more preferably 20 or more, and preferably 1000 or less, more preferably 500 or less, still more preferably 200 or less.

Specific examples of the siloxane backbone-containing group include groups represented by the following formulae.

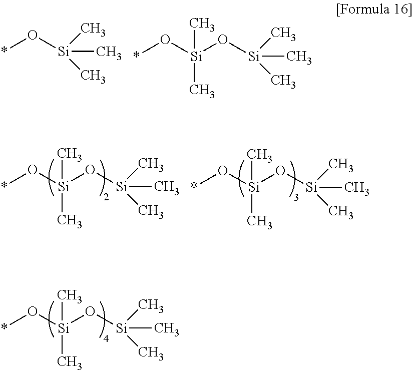

r1 in formula (c1) represents an integer of 1 to 3, and is preferably 2 or 3, more preferably 3.

Examples of the compound (C1) represented by formula (c1) include compounds represented by the following formula (c1-1), i.e. compounds in which R^{c1} in formula (c1) is a group represented by formula (c11-1) and r1 in formula (c1) is 3.

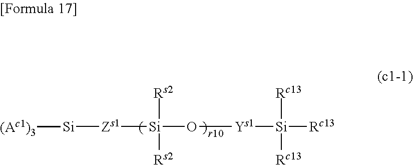

In formula (c1-1), A^{c1}, Z^{s1}, R^{s2}, Y^{s1}, R^{c13} and r10 have the same meanings as those described above.

Among the compounds represented by formula (c1-1), a compound represented by the following formula (I-1) is preferable, and a compound represented by formula (I-1-1) is more preferable. The compound represented by formula (c1-1) may be a compound represented by the following formula (I-2), and is preferably a compound represented by formula (I-2-1).

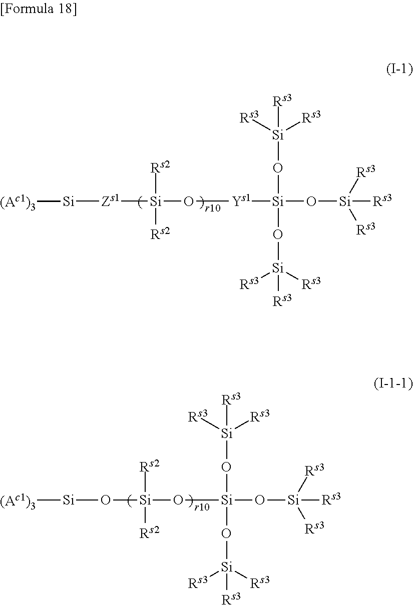

In formulae (I-1) and (I-1-1), A^{c1}, Z^{s1}, R^{s2}, Y^{s1}, R^{r3} and r10 have the same meanings as those described above.

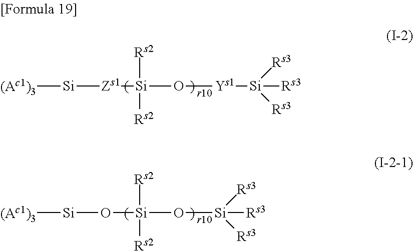

In formulae (I-2) and (I-2-1), A^{c1}, Z^{s1}, R^{s2}, Y^{s1}, R^{s3} and r10 have the same meanings as those described above.

Specific examples of the compound represented by formula (c1-1) include compounds represented by formula (I-I). In formula (I-I), combinations of A^{a20}, Z^{s10}, R^{s20}, n10, Y^{s10} and R^{s10} are preferably those shown in the tables below.

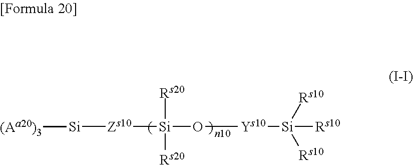

TABLE 4-1

| | A^{a20} | Z^{s10} | R^{s20} | n10 | Y^{s10} | R^{s10} |
|---|---|---|---|---|---|---|
| (I-I-1) | C₂H₅O—* | *—O—* | CH₃—* | 1~60 | — | (CH₃)₃SiO—* |
| (I-I-2) | C₂H₅O—* | *—O—* | CH₃—* | 1~60 | *—Si(CH₃)₂—CH₂—* | (CH₃)₃SiO—* |
| (I-I-3) | C₂H₅O—* | *—O—* | CH₃—* | 1~60 | *—Si(CH₃)₂—(CH₂)₂—* | (CH₃)₃SiO—* |
| (I-I-4) | C₂H₅O—* | *—O—* | CH₃—* | 1~60 | *—Si(CH₃)₂—(CH₂)₃—* | (CH₃)₃SiO—* |
| (I-I-5) | C₂H₅O—* | *—O—* | CH₃—* | 1~60 | *—Si(CH₃)₂—(CH₂)₄—* | (CH₃)₃SiO—* |
| (I-I-6) | C₂H₅O—* | *—CH₂—* | CH₃—* | 1~60 | — | (CH₃)₃SiO—* |
| (I-I-7) | C₂H₅O—* | *—CH₂—* | CH₃—* | 1~60 | *—Si(CH₃)₂—CH₂—* | (CH₃)₃SiO—* |
| (I-I-8) | C₂H₅O—* | *—CH₂—* | CH₃—* | 1~60 | *—Si(CH₃)₂—(CH₂)₂—* | (CH₃)₃SiO—* |
| (I-I-9) | C₂H₅O—* | *—CH₂—* | CH₃—* | 1~60 | *—Si(CH₃)₂—(CH₂)₃—* | (CH₃)₃SiO—* |
| (I-I-10) | C₂H₅O—* | *—CH₂—* | CH₃—* | 1~60 | *—Si(CH₃)₂—(CH₂)₄—* | (CH₃)₃SiO—* |
| (I-I-11) | C₂H₅O—* | *—(CH₂)₂—* | CH₃—* | 1~60 | — | (CH₃)₃SiO—* |
| (I-I-12) | C₂H₅O—* | *—(CH₂)₂—* | CH₃—* | 1~60 | *—Si(CH₃)₂—CH₂—* | (CH₃)₃SiO—* |
| (I-I-13) | C₂H₅O—* | *—(CH₂)₂—* | CH₃—* | 1~60 | *—Si(CH₃)₂—(CH₂)₂—* | (CH₃)₃SiO—* |
| (I-I-14) | C₂H₅O—* | *—(CH₂)₂—* | CH₃—* | 1~60 | *—Si(CH₃)₂—(CH₂)₃—* | (CH₃)₃SiO—* |
| (I-I-15) | C₂H₅O—* | *—(CH₂)₂—* | CH₃—* | 1~60 | *—Si(CH₃)₂—(CH₂)₄—* | (CH₃)₃SiO—* |
| (I-I-16) | C₂H₅O—* | *—(CH₂)₃—* | CH₃—* | 1~60 | — | (CH₃)₃SiO—* |
| (I-I-17) | C₂H₅O—* | *—(CH₂)₃—* | CH₃—* | 1~60 | *—Si(CH₃)₂—CH₂—* | (CH₃)₃SiO—* |
| (I-I-18) | C₂H₅O—* | *—(CH₂)₃—* | CH₃—* | 1~60 | *—Si(CH₃)₂—(CH₂)₂—* | (CH₃)₃SiO—* |
| (I-I-19) | C₂H₅O—* | *—(CH₂)₃—* | CH₃—* | 1~60 | *—Si(CH₃)₂—(CH₂)₃—* | (CH₃)₃SiO—* |
| (I-I-20) | C₂H₅O—* | *—(CH₂)₃—* | CH₃—* | 1~60 | *—Si(CH₃)₂—(CH₂)₄—* | (CH₃)₃SiO—* |
| (I-I-21) | C₂H₅O—* | *—(CH₂)₄—* | CH₃—* | 1~60 | — | (CH₃)₃SiO—* |
| (I-I-22) | C₂H₅O—* | *—(CH₂)₄—* | CH₃—* | 1~60 | *—Si(CH₃)₂—CH₂—* | (CH₃)₃SiO—* |
| (I-I-23) | C₂H₅O—* | *—(CH₂)₄—* | CH₃—* | 1~60 | *—Si(CH₃)₂—(CH₂)₂—* | (CH₃)₃SiO—* |
| (I-I-24) | C₂H₅O—* | *—(CH₂)₄—* | CH₃—* | 1~60 | *—Si(CH₃)₂—(CH₂)₃—* | (CH₃)₃SiO—* |
| (I-I-25) | C₂H₅O—* | *—(CH₂)₄—* | CH₃—* | 1~60 | *—Si(CH₃)₂—(CH₂)₄—* | (CH₃)₃SiO—* |

TABLE 4-2

| | A^{a20} | Z^{s10} | R^{s20} | n10 | Y^{s10} | R^{s10} |
|---|---|---|---|---|---|---|
| (I-I-26) | CH₃O—* | *—O—* | CH₃—* | 1~60 | — | (CH₃)₃SiO—* |
| (I-I-27) | CH₃O—* | *—O—* | CH₃—* | 1~60 | *—Si(CH₃)₂—CH₂—* | (CH₃)₃SiO—* |
| (I-I-28) | CH₃O—* | *—O—* | CH₃—* | 1~60 | *—Si(CH₃)₂—(CH₂)₂—* | (CH₃)₃SiO—* |
| (I-I-29) | CH₃O—* | *—O—* | CH₃—* | 1~60 | *—Si(CH₃)₂—(CH₂)₃—* | (CH₃)₃SiO—* |
| (I-I-30) | CH₃O—* | *—O—* | CH₃—* | 1~60 | *—Si(CH₃)₂—(CH₂)₄—* | (CH₃)₃SiO—* |
| (I-I-31) | CH₃O—* | *—CH₂—* | CH₃—* | 1~60 | — | (CH₃)₃SiO—* |
| (I-I-32) | CH₃O—* | *—CH₂—* | CH₃—* | 1~60 | *—Si(CH₃)₂—CH₂—* | (CH₃)₃SiO—* |
| (I-I-33) | CH₃O—* | *—CH₂—* | CH₃—* | 1~60 | *—Si(CH₃)₂—(CH₂)₂—* | (CH₃)₃SiO—* |
| (I-I-34) | CH₃O—* | *—CH₂—* | CH₃—* | 1~60 | *—Si(CH₃)₂—(CH₂)₃—* | (CH₃)₃SiO—* |
| (I-I-35) | CH₃O—* | *—CH₂—* | CH₃—* | 1~60 | *—Si(CH₃)₂—(CH₂)₄—* | (CH₃)₃SiO—* |
| (I-I-36) | CH₃O—* | *—(CH₂)₂—* | CH₃—* | 1~60 | — | (CH₃)₃SiO—* |
| (I-I-37) | CH₃O—* | *—(CH₂)₂—* | CH₃—* | 1~60 | *—Si(CH₃)₂—CH₂—* | (CH₃)₃SiO—* |
| (I-I-38) | CH₃O—* | *—(CH₂)₂—* | CH₃—* | 1~60 | *—Si(CH₃)₂—(CH₂)₂—* | (CH₃)₃SiO—* |
| (I-I-39) | CH₃O—* | *—(CH₂)₂—* | CH₃—* | 1~60 | *—Si(CH₃)₂—(CH₂)₃—* | (CH₃)₃SiO—* |
| (I-I-40) | CH₃O—* | *—(CH₂)₂—* | CH₃—* | 1~60 | *—Si(CH₃)₂—(CH₂)₄—* | (CH₃)₃SiO—* |
| (I-I-41) | CH₃O—* | *—(CH₂)₃—* | CH₃—* | 1~60 | — | (CH₃)₃SiO—* |
| (I-I-42) | CH₃O—* | *—(CH₂)₃—* | CH₃—* | 1~60 | *—Si(CH₃)₂—CH₂—* | (CH₃)₃SiO—* |
| (I-I-43) | CH₃O—* | *—(CH₂)₃—* | CH₃—* | 1~60 | *—Si(CH₃)₂—(CH₂)₂—* | (CH₃)₃SiO—* |
| (I-I-44) | CH₃O—* | *—(CH₂)₃—* | CH₃—* | 1~60 | *—Si(CH₃)₂—(CH₂)₃—* | (CH₃)₃SiO—* |
| (I-I-45) | CH₃O—* | *—(CH₂)₃—* | CH₃—* | 1~60 | *—Si(CH₃)₂—(CH₂)₄—* | (CH₃)₃SiO—* |
| (I-I-46) | CH₃O—* | *—(CH₂)₄—* | CH₃—* | 1~60 | — | (CH₃)₃SiO—* |
| (I-I-47) | CH₃O—* | *—(CH₂)₄—* | CH₃—* | 1~60 | *—Si(CH₃)₂—CH₂—* | (CH₃)₃SiO—* |
| (I-I-48) | CH₃O—* | *—(CH₂)₄—* | CH₃—* | 1~60 | *—Si(CH₃)₂—(CH₂)₂—* | (CH₃)₃SiO—* |
| (I-I-49) | CH₃O—* | *—(CH₂)₄—* | CH₃—* | 1~60 | *—Si(CH₃)₂—(CH₂)₃—* | (CH₃)₃SiO—* |
| (I-I-50) | CH₃O—* | *—(CH₂)₄—* | CH₃—* | 1~60 | *—Si(CH₃)₂—(CH₂)₄—* | (CH₃)₃SiO—* |

TABLE 5-1

| | A^{a20} | Z^{s10} | R^{s20} | n10 | Y^{s10} | R^{s10} |
|---|---|---|---|---|---|---|
| (I-I-51) | C₂H₅O—* | *—O—* | CH₃—* | 1~60 | — | CH₃—* |
| (I-I-52) | C₂H₅O—* | *—O—* | CH₃—* | 1~60 | *—Si(CH₃)₂—CH₂—* | CH₃—* |
| (I-I-53) | C₂H₅O—* | *—O—* | CH₃—* | 1~60 | *—Si(CH₃)₂—(CH₂)₂—* | CH₃—* |
| (I-I-54) | C₂H₅O—* | *—O—* | CH₃—* | 1~60 | *—Si(CH₃)₂—(CH₂)₃—* | CH₃—* |
| (I-I-55) | C₂H₅O—* | *—O—* | CH₃—* | 1~60 | *—Si(CH₃)₂—(CH₂)₄—* | CH₃—* |
| (I-I-56) | C₂H₅O—* | *—CH₂—* | CH₃—* | 1~60 | — | CH₃—* |
| (I-I-57) | C₂H₅O—* | *—CH₂—* | CH₃—* | 1~60 | *—Si(CH₃)₂—CH₂—* | CH₃—* |
| (I-I-58) | C₂H₅O—* | *—CH₂—* | CH₃—* | 1~60 | *—Si(CH₃)₂—(CH₂)₂—* | CH₃—* |
| (I-I-59) | C₂H₅O—* | *—CH₂—* | CH₃—* | 1~60 | *—Si(CH₃)₂—(CH₂)₃—* | CH₃—* |
| (I-I-60) | C₂H₅O—* | *—CH₂—* | CH₃—* | 1~60 | *—Si(CH₃)₂—(CH₂)₄—* | CH₃—* |
| (I-I-61) | C₂H₅O—* | *—(CH₂)₂—* | CH₃—* | 1~60 | — | CH₃—* |
| (I-I-62) | C₂H₅O—* | *—(CH₂)₂—* | CH₃—* | 1~60 | *—Si(CH₃)₂—CH₂—* | CH₃—* |
| (I-I-63) | C₂H₅O—* | *—(CH₂)₂—* | CH₃—* | 1~60 | *—Si(CH₃)₂—(CH₂)₂—* | CH₃—* |
| (I-I-64) | C₂H₅O—* | *—(CH₂)₂—* | CH₃—* | 1~60 | *—Si(CH₃)₂—(CH₂)₃—* | CH₃—* |
| (I-I-65) | C₂H₅O—* | *—(CH₂)₂—* | CH₃—* | 1~60 | *—Si(CH₃)₂—(CH₂)₄—* | CH₃—* |
| (I-I-66) | C₂H₅O—* | *—(CH₂)₃—* | CH₃—* | 1~60 | — | CH₃—* |
| (I-I-67) | C₂H₅O—* | *—(CH₂)₃—* | CH₃—* | 1~60 | *—Si(CH₃)₂—CH₂—* | CH₃—* |
| (I-I-68) | C₂H₅O—* | *—(CH₂)₃—* | CH₃—* | 1~60 | *—Si(CH₃)₂—(CH₂)₂—* | CH₃—* |
| (I-I-69) | C₂H₅O—* | *—(CH₂)₃—* | CH₃—* | 1~60 | *—Si(CH₃)₂—(CH₂)₃—* | CH₃—* |
| (I-I-70) | C₂H₅O—* | *—(CH₂)₃—* | CH₃—* | 1~60 | *—Si(CH₃)₂—(CH₂)₄—* | CH₃—* |
| (I-I-71) | C₂H₅O—* | *—(CH₂)₄—* | CH₃—* | 1~60 | — | CH₃—* |
| (I-I-72) | C₂H₅O—* | *—(CH₂)₄—* | CH₃—* | 1~60 | *—Si(CH₃)₂—CH₂—* | CH₃—* |
| (I-I-73) | C₂H₅O—* | *—(CH₂)₄—* | CH₃—* | 1~60 | *—Si(CH₃)₂—(CH₂)₂—* | CH₃—* |
| (I-I-74) | C₂H₅O—* | *—(CH₂)₄—* | CH₃—* | 1~60 | *—Si(CH₃)₂—(CH₂)₃—* | CH₃—* |
| (I-I-75) | C₂H₅O—* | *—(CH₂)₄—* | CH₃—* | 1~60 | *—Si(CH₃)₂—(CH₂)₄—* | CH₃—* |

TABLE 5-2

| | A^{a20} | Z^{s10} | R^{s20} | n10 | Y^{s10} | R^{s10} |
|---|---|---|---|---|---|---|
| (I-I-76) | CH₃O—* | *—O—* | CH₃—* | 1~60 | — | CH₃—* |
| (I-I-77) | CH₃O—* | *—O—* | CH₃—* | 1~60 | *—Si(CH₃)₂—CH₂—* | CH₃—* |
| (I-I-78) | CH₃O—* | *—O—* | CH₃—* | 1~60 | *—Si(CH₃)₂—(CH₂)₂—* | CH₃—* |
| (I-I-79) | CH₃O—* | *—O—* | CH₃—* | 1~60 | *—Si(CH₃)₂—(CH₂)₃—* | CH₃—* |
| (I-I-80) | CH₃O—* | *—O—* | CH₃—* | 1~60 | *—Si(CH₃)₂—(CH₂)₄—* | CH₃—* |
| (I-I-81) | CH₃O—* | *—CH₂—* | CH₃—* | 1~60 | — | CH₃—* |
| (I-I-82) | CH₃O—* | *—CH₂—* | CH₃—* | 1~60 | *—Si(CH₃)₂—CH₂—* | CH₃—* |
| (I-I-83) | CH₃O—* | *—CH₂—* | CH₃—* | 1~60 | *—Si(CH₃)₂—(CH₂)₂—* | CH₃—* |
| (I-I-84) | CH₃O—* | *—CH₂—* | CH₃—* | 1~60 | *—Si(CH₃)₂—(CH₂)₃—* | CH₃—* |
| (I-I-85) | CH₃O—* | *—CH₂—* | CH₃—* | 1~60 | *—Si(CH₃)₂—(CH₂)₄—* | CH₃—* |
| (I-I-86) | CH₃O—* | *—(CH₂)₂—* | CH₃—* | 1~60 | — | CH₃—* |
| (I-I-87) | CH₃O—* | *—(CH₂)₂—* | CH₃—* | 1~60 | *—Si(CH₃)₂—CH₂—* | CH₃—* |
| (I-I-88) | CH₃O—* | *—(CH₂)₂—* | CH₃—* | 1~60 | *—Si(CH₃)₂—(CH₂)₂—* | CH₃—* |
| (I-I-89) | CH₃O—* | *—(CH₂)₂—* | CH₃—* | 1~60 | *—Si(CH₃)₂—(CH₂)₃—* | CH₃—* |
| (I-I-90) | CH₃O—* | *—(CH₂)₂—* | CH₃—* | 1~60 | *—Si(CH₃)₂—(CH₂)₄—* | CH₃—* |
| (I-I-91) | CH₃O—* | *—(CH₂)₃—* | CH₃—* | 1~60 | — | CH₃—* |
| (I-I-92) | CH₃O—* | *—(CH₂)₃—* | CH₃—* | 1~60 | *—Si(CH₃)₂—CH₂—* | CH₃—* |
| (I-I-93) | CH₃O—* | *—(CH₂)₃—* | CH₃—* | 1~60 | *—Si(CH₃)₂—(CH₂)₂—* | CH₃—* |
| (I-I-94) | CH₃O—* | *—(CH₂)₃—* | CH₃—* | 1~60 | *—Si(CH₃)₂—(CH₂)₃—* | CH₃—* |
| (I-I-95) | CH₃O—* | *—(CH₂)₃—* | CH₃—* | 1~60 | *—Si(CH₃)₂—(CH₂)₄—* | CH₃—* |
| (I-I-96) | CH₃O—* | *—(CH₂)₄—* | CH₃—* | 1~60 | — | CH₃—* |
| (I-I-97) | CH₃O—* | *—(CH₂)₄—* | CH₃—* | 1~60 | *—Si(CH₃)₂—CH₂—* | CH₃—* |
| (I-I-98) | CH₃O—* | *—(CH₂)₄—* | CH₃—* | 1~60 | *—Si(CH₃)₂—(CH₂)₂—* | CH₃—* |
| (I-I-99) | CH₃O—* | *—(CH₂)₄—* | CH₃—* | 1~60 | *—Si(CH₃)₂—(CH₂)₃—* | CH₃—* |
| (I-I-100) | CH₃O—* | *—(CH₂)₄—* | CH₃—* | 1~60 | *—Si(CH₃)₂—(CH₂)₄—* | CH₃—* |

n10 shown in Tables 4-1, 4-2, 5-1 and 5-2 above is preferably an integer of 1 to 30.

Among the compounds represented by the above formula (I-I), a compound represented by formula (1-1-26) is more preferable. That is, the compound (C1) is preferably a compound represented by the following formula (c1-I).

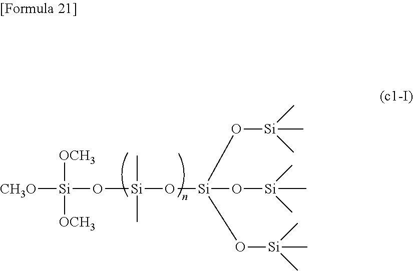

In formula (c1-I), n represents an integer of 1 to 60.

n is more preferably an integer of 2 or more, still more preferably an integer of 3 or more, and more preferably an integer of 50 or less, still more preferably an integer of 45 or less, particularly preferably an integer of 30 or less, most preferably an integer of 25 or less.

Examples of the method for synthesizing the compound represented by formula (c1-1) include a method described in Japanese Patent Laid-Open No. 2017-201009.

As the compound (C1) represented by formula (c1), “X-24-9011” manufactured by Shin-Etsu Chemical Co., Ltd., or the like can be used. “X-24-9011” manufactured by Shin-Etsu Chemical Co., Ltd. and represented by the following formula is a compound having a trimethoxysilyl group only at one end of one side and no hydroxy group and hydrolyzable group at the other end and containing a siloxane bond in the structure. The compound is represented by formula (c1) where r1 is 3, A^{c1} represents a methoxy group, and R^{c1} is a group of formula (c11-1), and the compound has a weight average molecular weight of 3400.

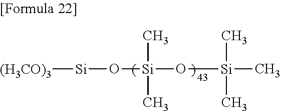

Examples of the compound (C1) represented by formula (c1) also include compounds represented by formula (c1-2), i.e. compounds in which R^{c1} in formula (c1) is a group represented by formula (c11-2) and Z^{c1} in formula (c1) is a hydrocarbon group.

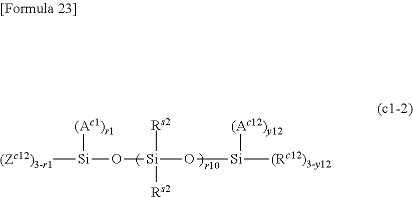

In formula (c1-2), A^{c1}, R^{L2}, A^{c12}, R^{c12}, r1, r10 and y12 have the same meanings as those described above, Z^{c12} represents a hydrocarbon group, a plurality of Z^{c12}s, when present, are optionally different from each other.

In formula (c1-2), A^{c1} and A^{c12} may be the same or different, and are preferably the same.

Examples of the hydrocarbon group represented by Z^{c12} include those similar to the groups described for Z^{c1} above, and the hydrocarbon group is preferably a methyl group or an ethyl group, with a methyl group being more preferable. Z^{c12} and R^{c12} may be the same or different, and are preferably the same.

r1 and y12 are each preferably 1 or 3. r1 and y12 may be the same or different, and are preferably the same.

As the compound represented by formula (c1-2), a compound is preferably used where R^{s2} is a methyl group, r10 represents an integer of 1 to 60, each of A^{c1} and A^{c12} is an alkoxy group having 1 or 2 carbon atoms, or a hydroxy group, each of Z^{c12} and R^{c12} is a methyl group or an ethyl group, and r1 and y12 are the same, and each represent an integer of 1 to 3.

Specific examples of the compound represented by formula (c1-2) include compounds represented by formula (I-II). In formula (I-II), combinations of A^{c00}, Z^{c0}, R^{s22}, n20, y0, A^{c0} and R^{c0} are preferably those shown in the table below.

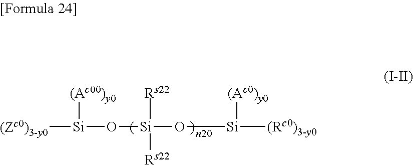

TABLE 6

| | A^{c00} | Z^{c0} | R^{s22} | n20 | y0 | A^{c0} | R^{c0} |
|---|---|---|---|---|---|---|---|
| (I-II-1) | C₂H₅O—* | CH₃—* | CH₃—* | 1~60 | 1 | C₂H₅O—* | CH₃—* |
| (I-II-2) | CH₃O—* | CH₃—* | CH₃—* | 1~60 | 1 | CH₃O—* | CH₃—* |
| (I-II-3) | HO—* | CH₃—* | CH₃—* | 1~60 | 1 | HO—* | CH₃—* |
| (I-II-4) | C₂H₅O—* | C₂H₅—* | CH₃—* | 1~60 | 1 | C₂H₅O—* | C₂H₅—* |
| (I-II-5) | CH₃O—* | C₂H₅—* | CH₃—* | 1~60 | 1 | CH₃O—* | C₂H₅—* |
| (I-II-6) | HO—* | C₂H₅—* | CH₃—* | 1~60 | 1 | HO—* | C₂H₅—* |
| (I-II-7) | C₂H₅O—* | CH₃—* | CH₃—* | 1~60 | 2 | C₂H₅O—* | CH₃—* |
| (I-II-8) | CH₃O—* | CH₃—* | CH₃—* | 1~60 | 2 | CH₃O—* | CH₃—* |
| (I-II-9) | HO—* | CH₃—* | CH₃—* | 1~60 | 2 | HO—* | CH₃—* |
| (I-II-10) | C₂H₅O—* | C₂H₅—* | CH₃—* | 1~60 | 2 | C₂H₅O—* | C₂H₅—* |
| (I-II-11) | CH₃O—* | C₂H₅—* | CH₃—* | 1~60 | 2 | CH₃O—* | C₂H₅—* |
| (I-II-12) | HO—* | C₂H₅—* | CH₃—* | 1~60 | 2 | HO—* | C₂H₅—* |
| (I-II-13) | C₂H₅O—* | — | CH₃—* | 1~60 | 3 | C₂H₅O—* | — |
| (I-II-14) | CH₃O—* | — | CH₃—* | 1~60 | 3 | CH₃O—* | — |
| (I-II-15) | HO—* | — | CH₃—* | 1~60 | 3 | HO—* | — |

As the compound represented by formula (c1-2), compounds (I-II-1) to (1-11-3) and (1-11-13) to (1-11-15) are preferable, and the compound (I-II-3), the compound (I-II-13) or the compound (I-II-14) is more preferable.

As the compound (C1) represented by formula (c1), “DMS-S12” manufactured by Gelest Inc., “KR-410” manufactured by Shin-Etsu Chemical Co., Ltd. or the like can also be used. “DMS-S12” manufactured by Gelest Inc. is a compound in which n20 is 4 to 7 in formula (I-II-3) shown in Table 6 above. “KR-410” manufactured by Shin-Etsu Chemical Co., Ltd. is a compound in which n20 is 10 in formula (I-II-14) shown in Table 6 above.

The compound (C1) represented by formula (c1) is preferably a compound represented by formula (c1-1) or a compound represented by formula (c1-2), more preferably a compound represented by formula (c1-1).

The compounds (C1) may be used alone, or used in combination of two or more thereof.

When the total amount of the curable composition is 100 mass %, the amount of the amount of the compound (C1) is preferably 0.01 mass % or less, more preferably 0.005 mass % or less, still more preferably 0.002 mass % or less, and preferably 0.00001 mass % or more, more preferably 0.00005 mass % or more, still more preferably 0.0001 mass % or more.

The molar ratio (C1/A) of the compound (C1) to the organosilicon compound (A) is preferably 0.00001 or more, more preferably 0.00005 or more, still more preferably 0.0001 or more, and preferably 0.005 or less, more preferably 0.001 or less.

The mass ratio [C1/(A+B)] of the compound (C1) to the total amount of the organosilicon compound (A) and the organosilicon compound (B) is preferably 0.058 or less, more preferably 0.01 or less, still more preferably 0.001 or less, and preferably 0.0001 or more, more preferably 0.0003 or more, still more preferably 0.0005 or more.

When the total amount of the curable composition is 100 mass %, the total amount of the organosilicon compound (A), the organosilicon compound (B) and the compound (C1) is preferably 0.01 mass % or more, more preferably 0.1 mass % or more, still more preferably 0.3 mass % or more, furthermore preferably 0.4 mass % or more, particularly preferably 0.6 mass % or more, and preferably 10 mass % or less, more preferably 4 mass % or less, still more preferably 2 mass % or less, furthermore preferably 1.5 mass % or less, particularly preferably 1 mass % or less.

In the curable composition, water (D) may be mixed.

When the total amount of the curable composition is 100 mass %, the amount of the water (D) is preferably 0.1 mass % or more, more preferably 1 mass % or more, still more preferably 3 mass % or more, furthermore preferably 5 mass % or more, furthermore preferably 10 mass % or more, particularly preferably 15 mass % or more, most preferably 20 mass % or more, and preferably 50 mass % or less, more preferably 40 mass % or less, still more preferably 35 mass % or less, particularly preferably 30 mass % or less.

The mass ratio (D/A) of the amount of the water (D) to the organosilicon compound (A) is preferably 20 or more. The mass ratio (D/A) is more preferably 25 or more, still more preferably 30 or more. The upper limit of the mass ratio (D/A) is, for example, 150 or less, preferably 120 or less, more preferably 100 or less, furthermore preferably 80 or less, particularly preferably 70 or less.

It is preferable that in the curable composition of the present invention, at least one of a solvent (E), a catalyst (F) and a weak acid (G) having pKa of 1 or more and 5 or less be mixed in addition to the above-described components.

### [Solvent (E)]

Examples of the solvent (E) include hydrophilic organic solvents such as alcohol-based solvents, ether-based solvents, ketone-based solvents, ester-based solvents and amide-based solvents. These solvents may be used alone, or used in combination of two or more thereof. Examples of the alcohol-based solvent include ethanol, 1-propanol, 2-propanol, butanol, ethylene glycol, propylene glycol and diethylene glycol. Examples of the ether-based solvent include dimethoxyethane and dioxane. Examples of the ketone-based solvent include methyl isobutyl ketone. Examples of the ester-based solvent include ethyl acetate and butyl acetate. Examples of the amide-based solvent include dimethylformamide. In particular, the solvent (E) is preferably an alcohol-based solvent, more preferably 2-propanol or ethanol.

The solvent (E) may be adjusted according to the material of a base material on which a film is formed by applying the curable composition. For example, it is preferable to use a ketone-based solvent when a base material of an organic material is used, and it is preferable to use an alcohol-based solvent when a base material of an inorganic material is used.

When the total amount of the curable composition is 100 mass %, the amount of the solvent (E) is preferably 10 mass % or more, more preferably 20 mass % or more, still more preferably 30 mass % or more, particularly preferably 40 mass % or more, most preferably 60 mass % or more, and preferably 95 mass % or less, more preferably 90 mass % or less, still more preferably 85 mass % or less, furthermore preferably 80 mass % or less.

### [Catalyst (F)]

As the catalyst (F), inorganic acids such as hydrogen chloride (normally used in the form of hydrochloric acid), phosphoric acid and nitric acid; carboxylic acid compounds (organic acids) such as maleic acid, malonic acid, formic acid, benzoic acid, phenylethanoic acid, butanoic acid, 2-methylpropanoic acid, propanoic acid, 2,2-dimethylpropanoic acid and acetic acid; basic compounds such as ammonia and amine; organometallic compounds such as aluminum ethylacetoacetate compounds; and the like can be used. As the catalyst (F), acidic compounds such as inorganic acids and organic acids are preferably used, inorganic acids are more preferable, and hydrogen chloride (hydrochloric acid) is still more preferable. The catalysts (F) may be used alone, or used in combination of two or more thereof.

When the total amount of the curable composition is 100 mass %, the amount of the catalyst (F) is preferably 0.00001 mass % or more, more preferably 0.0001 mass % or more, still more preferably 0.0002 mass % or more, and preferably 0.01 mass % or less, more preferably 0.005 mass % or less, still more preferably 0.003 mass % or less, furthermore preferably 0.001 mass % or less.

The mass ratio [F/(A+B)] of the catalyst (F) to the total amount of the organosilicon compound (A) and the organosilicon compound (B) is preferably 0.00001 or more, more preferably 0.00005 or more, still more preferably 0.0001 or more, and preferably 0.03 or less, more preferably 0.02 or less, still more preferably 0.01 or less, particularly preferably 0.001 or less.

### [Weak Acid (G) Having pKa of 1 or More and 5 or Less]

When a catalyst other than a phosphoric acid or carboxylic acid compound is used as the catalyst (F), it is preferable that in the curable composition of the present invention, the weak acid (G) having a pKa of 1 or more and 5 or less be mixed. This enables suppression of impairment of storage stability due to gelation of the curable composition.

The pKa of the weak acid (G) is preferably 4.3 or less, more preferably 4.0 or less, still more preferably 3.5 or less. The pKa of the weak acid (G) is, for example, 1 or more. When the weak acid (G) has a plurality of pKas, whether or not the range of pKa is satisfied is determined on the basis of the smallest pKa.

The weak acid (G) may be either an inorganic acid or an organic acid, and examples thereof include carboxylic acid compounds and phosphoric acid compounds. The weak acids (G) may be used alone, or used in combination of two or more thereof.

The carboxylic acid compound means a compound having at least one carboxy group, may be either a monovalent carboxylic acid compound or a polyvalent carboxylic acid compound (carboxylic acid compound having two or more carboxy groups), and is preferably a polyvalent carboxylic acid compound. The polyvalent carboxylic acid compound is more preferably oxalic acid with two carboxy groups directly bonded to each other, or a polyvalent carboxylic acid compound in which a carboxy group is bonded to each of both ends of a divalent hydrocarbon group and the main chain (longest linear chain) of the hydrocarbon group has 1 to 15 carbon atoms (more preferably 1 to 5, still more preferably 1 to 4, furthermore preferably 1 to 3, particularly preferably 1 or 2 carbon atoms) (particularly dicarboxylic acid, tricarboxylic acid or tetracarboxylic acid).

The divalent hydrocarbon group may be linear or branched, may be an aliphatic hydrocarbon group or an aromatic hydrocarbon group, and may be a saturated hydrocarbon group or an unsaturated hydrocarbon group, and hydroxy groups or carboxy groups may be bonded to carbon atoms other than those at both ends of the hydrocarbon group.

Examples of the carboxylic acid compound include dicarboxylic acids such as oxalic acid (pKa=1.27), malonic acid (pKa=2.60), succinic acid (pKa=3.99), maleic acid (pKa=1.84), fumaric acid (pKa=3.02), glutaric acid (pKa=4.13), adipic acid (pKa=4.26), pimelic acid (pKa=4.71), tartaric acid (pKa=2.98), malic acid (pKa=3.23), phthalic acid (pKa=2.89), itaconic acid (pKa=3.85), muconic acid (pKa=3.87), 1,4-cyclohexanedicarboxylic acid (pKa=4.51), 1,4-naphthalenedicarboxylic acid, 2,6-naphthalenedicarboxylic acid (pKa=3.69), 2,7-naphthalenedicarboxylic acid (pKa=3.72) and 4,4′-biphenyldicarboxylic acid (pKa=3.77); tricarboxylic acids such as citric acid (pKa=2.90), aconitic acid (pKa=2.8), trimellitic acid (pKa=2.52), trimesic acid, biphenyl-3,4′,5-tricarboxylic acid (pKa=3.36) and tricarballylic acid (pKa=3.49); and tetracarboxylic acid such as butanetetracarboxylic acid (pKa=3.25).

The carboxylic acid compound is more preferably oxalic acid, dicarboxylic acid with a carboxy group bonded to each of both ends of a saturated or unsaturated linear hydrocarbon group having 1 to 3 carbon atoms (particularly 1 or 2 carbon atoms), or tricarboxylic acid. Specifically, the carboxylic acid compound is preferably oxalic acid, malonic acid, succinic acid, maleic acid, glutaric acid, tricarballylic acid or the like, more preferably oxalic acid, malonic acid, succinic acid, maleic acid or tricarballylic acid.

The carboxylic acid compound may be a polymer having at least one carboxy group in the molecule. Examples of the polymer include polymers containing a structural unit having a carboxy group on a side chain, and the polymer may contain two or more structural units having a carboxy group on a side chain. Examples of the polymer having at least carboxy group in the molecule include (meth)acrylic polymers having a carboxy group, polyester polymers having a carboxy group, and polyolefin polymers having a carboxy group.

The molecular weight of the carboxylic acid compound is preferably 1000 or less, more preferably 500 or less. The molecular weight is preferably 50 or more, more preferably 80 or more, still more preferably 90 or more.

The carboxylic acid compound is preferably a compound represented by the following formula (g1).

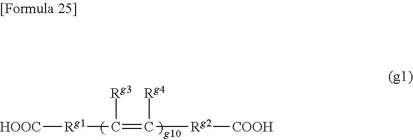

In the above formula (g1), R^{g1} and R^{g2} each independently represent a divalent aliphatic hydrocarbon group having 1 to 10 carbon atoms and optionally having a carboxy group and/or a hydroxy group, a divalent aromatic hydrocarbon group having 6 to 10 carbon atoms and optionally having a carboxy group, or a single bond. R^{g3} and R^{g4} each independently represent an alkyl group having 1 to 10 carbon atoms and optionally having a carboxy group, a carboxy group, or a hydrogen atom. g10 is 0 or 1.

The divalent aliphatic hydrocarbon group having 1 to 10 carbon atoms and represented by R^{g1} and R^{g2} may be linear, branched or cyclic. Specific examples thereof include alkanediyl groups such as a methylene group, an ethylene group, a propylene group and a butylene group.

Examples of the divalent aromatic hydrocarbon group having 6 to 10 carbon atoms and represented by R^{g1} and R^{g2} include a phenylene group.

The divalent aliphatic hydrocarbon groups represented by R^{g1} and R^{g2} optionally have a carboxy group and/or a hydroxy group, and the divalent aromatic hydrocarbon group optionally has a carboxy group.

R^{g1} is preferably a single bond, or a divalent aliphatic hydrocarbon group having 1 to 10 carbon atoms and optionally having a carboxy group, and R^{g1} is more preferably a single bond, or a divalent linear aliphatic hydrocarbon group having 1 to 10 carbon atoms and optionally having a carboxy group. R⁹² is preferably a single bond.

The alkyl groups having 1 to 10 carbon atoms and represented by R^{g3} and R^{g4} may be linear, branched or cyclic, and specific examples thereof include a methyl group, an ethyl group, a propyl group and a butyl group.

R^{g3} is preferably a hydrogen atom. R^{g4} is preferably a hydrogen atom.

The compound represented by the above formula (g1) is preferably a compound represented by the following formula (g2). In the following formula (g2), g20 is an integer of 0 to 2.

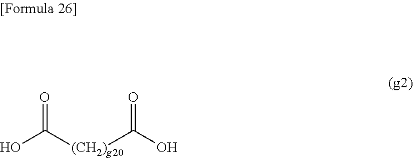

g20 is preferably 1.

The carboxylic acid compounds may be used alone, or used in combination of two or more thereof.

Examples of the phosphoric acid compound include orthophosphoric acid (pKa=1.83); and polyphosphoric acids such as pyrophosphoric acid (pKa=1.57), tripolyphosphoric acid (pKa=0.71), tetrapolyphosphoric acid (pKa=0.33), trimetaphosphoric acid, tetraphosphorus decaoxide and metaphosphoric acid. Among them, orthophosphoric acid is preferable. The phosphoric acid compounds may be used alone, or used in combination of two or more thereof.

When the total amount of the curable composition is 100 mass %, the amount of the weak acid (G) is preferably 0.00001 mass % or more, more preferably 0.00005 mass % or more, still more preferably 0.0001 mass % or more, particularly preferably 0.0005 mass % or more, most preferably 0.001 mass % or more, and preferably 3 mass % or less, more preferably 1 mass % or less, still more preferably 0.1 mass % or less, furthermore preferably 0.05 mass % or less, particularly preferably 0.03 mass % or less.

In the curable composition of the present invention, other components such as various additives such as oxidation inhibitors, antirust agents, ultraviolet absorbers, light stabilizers, fungicides, antibacterial agents, biofouling inhibitors, deodorants, pigments, flame retardants and antistatic agents may be mixed in the range not inhibiting the effects of the present invention.

The curable composition of the present invention can be used as a composition for producing a liquid-repellent film for imparting a liquid-repellent property to a base material. That is, the curable composition of the present invention can be used as a liquid-repellent film forming composition.

The curable composition of the present invention can be produced by mixing the above-described components, and in particular, the temperature at which the organosilicon compound (A) and the organosilicon compound (B) are mixed is preferably lower than 25° C., more preferably 24° C. or lower, still more preferably 20° C. or lower, particularly preferably 15° C. or lower, most preferably 10° C. or lower, from the viewpoint of setting the concentration fraction in the differential molecular weight distribution to a predetermined value. The lower limit of the mixing temperature may be, for example, 0° C. or higher.

When among the above-described components, the organosilicon compound (A), the organosilicon compound (B) and the compound (C1) are used, and the compound (C1) is mixed after the organosilicon compound (A) and the organosilicon compound (B) are mixed, the temperature is preferably lower than 25° C. until the compound (C1) is mixed, and the temperature may be 25° C. or higher after the compound (C1) is mixed.

When the organosilicon compound (A), the organosilicon compound (B) and the compound (C1) are mixed at the same time, or the organosilicon compound (A) and the organosilicon compound (B) are mixed after the compound (C1) is present, the mixing temperature may be 25° C. or higher.

The method for imparting a liquid-repellent property to a base material using the curable composition of the present invention is preferably a method in which using the curable composition of the present invention, a liquid-repellent film is formed on a surface of a base material to which a liquid-repellent property is desired to be imparted. As the method for forming a liquid-repellent film on a surface of a base material using the curable composition of the present invention, a method can be adopted in which the curable composition of the present invention is brought into contact with a base material, and left to stand in air in this state.

Examples of the method for bringing the curable composition of the present invention into contact with a base material include hand-coating (a method in which a cloth or the like is impregnated with the curable composition and the curable composition is rubbed against a base material, where, upon rubbing, it is preferable to move the cloth back and forth multiple times on the base material), a spin coating method, a dip coating method, pouring (a method in which the curable composition is directly dropped to a base material with a dropper or the like to perform coating), spraying (a base material is coated with the curable composition using a spray), and combinations of these methods.

By leaving the curable composition of the present invention to stand in air at normal temperature (e.g. for 10 minutes to 48 hours, preferably 10 hours to 48 hours) in a state of contact with the base material, the curable composition can be cured to form a film on the base material. It is also preferable to further dry the obtained film. The thickness of the film is preferably 1 nm or more, more preferably 1.5 nm or more, and the upper limit thereof is, for example, 50 nm or less, and may be 20 nm or less. It is preferable that the thickness of the film be above a certain level because exhibition of a good liquid-repellent property (water-repellent property in particular) with stability can be expected.

Examples of the material of the base material which is brought into contact with the curable composition of the present invention include organic materials and inorganic materials. Examples of the organic material include thermoplastic resins such as acrylic resin, polycarbonate resin, polyester resin, styrene resin, acryl-styrene copolymer resin, cellulose resin and polyolefin resin; and thermosetting resins such as phenol resin, urea resin, melamine resin, epoxy resin, unsaturated polyester, silicone resin and urethane resin. Examples of the inorganic material include ceramics; glass; metals such as iron, silicon, copper, zinc and aluminum; and alloys including any of the above-described metals.

The base material which is brought into contact with the curable composition of the present invention may have either a planar surface shape or a curved surface shape, or may have a three-dimensional structure in which many surfaces are combined.

The base material which is brought into contact with the curable composition of the present invention may be subjected to treatment for easy bonding in advance. Examples of the treatment for easy bonding include hydrophilization treatments such as corona treatment, plasma treatment and ultraviolet treatment. Primer treatment may be performed with resin, a silane coupling agent, a tetraalkoxysilane or the like, or a glass film of polysilazane or the like may be applied to a base material in advance.

The film obtained using the curable composition of the present invention is excellent in liquid-repellent property (water-repellent property in particular). The water-repellent property of the film can be evaluated in accordance with a measurement method in Examples described later.

The contact angle of a surface of the film with respect to water is, for example, 80° or more, preferably 90° or more, more preferably 98° or more, still more preferably 100° or more, furthermore preferably 105° or more, particularly preferably 106° or more. The upper limit is not particularly limited, and is, for example, 1200 or less.

The contact angle hysteresis (slip drop angle) of a surface of the film with respect to water is, for example, 20° or less, preferably 18° or less, more preferably 17° or less, still more preferably 16° or less. The lower limit is not particularly limited, and is, for example, 10° or more.

The slip drop speed of the water droplet on a surface of the film is, for example, 50 mm/sec or more, preferably 60 mm/sec or more, more preferably 70 mm/sec or more, still more preferably 80 mm/sec or more. The upper limit is not particularly limited, and is, for example, 150 mm/sec or less.

The curable composition of the present invention is excellent in storage stability, and even when a film is formed after storage of the curable composition, the obtained film is little inferior in performance to a film formed using the curable composition immediately after preparation.

The contact angle of a film formed using the stored curable composition with respect to water is, for example, 80° or more, preferably 90° or more, more preferably 98° or more, still more preferably 100° or more, furthermore preferably 105° or more. The upper limit is not particularly limited, and is, for example, 120° or less.

The contact angle hysteresis (slip drop angle) of a film formed using the stored curable composition with respect to water is, for example, 200 or less, preferably 19° or less, more preferably 18.5° or less. The lower limit is not particularly limited, and is, for example, 10° or more.

The slip drop speed of the water droplet on a film formed using the stored curable composition is, for example, 50 mm/sec or more, preferably 60 mm/sec or more, more preferably 70 mm/sec or more. The upper limit is not particularly limited, and is, for example, 150 mm/sec or less.

The curable composition of the present invention ensures easy formation of a film even after storage, and has good workability, for example, a good wiping property even when the film is formed by hand-coating.

By using the curable composition of the present invention, a film excellent in liquid-repellent property (water-repellent property in particular) can be provided. The curable composition of the present invention can provide a film excellent in liquid-repellent property (water-repellent property in particular) without deteriorating workability during film formation even after storage.

The film obtained using the curable composition of the present invention is useful for building materials, automobile parts and plant equipment, for example. In particular, by applying the curable composition of the present invention to glass for various vehicles and windowpanes of buildings, the liquid-repellent property can be improved, vehicle glass at least one surface of which is provided with a film obtained from the curable composition of the present invention is suitably used.

### EXAMPLES

Hereinafter, the present invention will be described in detail by way of Examples. The present invention is not limited by Examples below, and can be carried out while changes are appropriately made as long as the spirits described above and later can be met, and all of these changes are encompassed in the technical scope of the present invention.

### Example 1

2.17×10⁻³ moles of n-decyltrimethoxysilane as the organosilicon compound (A) and 2.17×10⁻³ moles of tetraethyl orthosilicate (tetraethoxysilane) as the organosilicon compound (B) were dissolved in 2.417 ml of isopropyl alcohol (2-propanol), and the solution was stirred at 15° C. for 10 minutes. To the obtained solution was added dropwise 1.073 ml of 0.01 M hydrochloric acid, and the mixture was stirred at 15° C. for 1 hour. To the obtained solution was added dropwise 0.392 ml of a solution of malonic acid diluted by 10 times in terms of mass ratio with isopropyl alcohol, and the mixture was stirred at 15° C. for 2 hours to prepare a sample solution 1. 5.000 ml of the sample solution 1, 74.866 ml of isopropyl alcohol, 20.000 ml of water, and 0.134 ml of a solution as the compound (C1), in which a compound with the average of n10 being 24 in (I-I-26) shown in Table 4-2 above (hereinafter, referred to as a compound 1) was diluted by 100 times in terms of mass ratio with isopropyl alcohol, were mixed to prepare a coating solution 1.

### Example 2

A coating solution 2 was prepared in the same manner as in Example 1 except that in preparation of the coating solution, the amount of the sample solution 1 was changed to 3.333 ml, the amount of isopropyl alcohol was changed to 76.577 ml, the amount of water was changed to 20.000 ml, and the amount of the solution of the compound 1 diluted by 100 times in terms of mass ratio with isopropyl alcohol was changed to 0.089 ml.

### Example 3

2.17×10⁻³ moles of n-decyltrimethoxysilane as the organosilicon compound (A) and 2.17×10⁻³ moles of tetraethyl orthosilicate (tetraethoxysilane) as the organosilicon compound (B) were dissolved in 2.417 ml of isopropyl alcohol (2-propanol), and the solution was stirred at 10° C. for 10 minutes. To the obtained solution was added dropwise 1.073 ml of 0.01 M hydrochloric acid, and the mixture was stirred at 10° C. for 1 hour. To the obtained solution was added dropwise 0.392 ml of a solution of malonic acid diluted by 10 times in terms of mass ratio with isopropyl alcohol, and the mixture was stirred at 10° C. for 2 hours to prepare a sample solution 2. 5.000 ml of the sample solution 2, 74.866 ml of isopropyl alcohol, 20.000 ml of water, and 0.134 ml of a solution of the compound 1 diluted by 100 times in terms of mass ratio with isopropyl alcohol were mixed to prepare a coating solution 3.

### Example 4

A coating solution 4 was prepared in the same manner as in Example 3 except that in preparation of the coating solution, the amount of the sample solution 2 was changed to 3.333 ml, the amount of isopropyl alcohol was changed to 76.577 ml, the amount of water was changed to 20.000 ml, and the amount of the solution of the compound 1 diluted by 100 times in terms of mass ratio with isopropyl alcohol was changed to 0.089 ml.

### Example 5

2.17×10⁻³ moles of n-decyltrimethoxysilane as the organosilicon compound (A) and 2.17×10⁻³ moles of tetraethyl orthosilicate (tetraethoxysilane) as the organosilicon compound (B) were dissolved in 2.417 ml of isopropyl alcohol (2-propanol), and the solution was stirred at 5° C. for 10 minutes. To the obtained solution was added dropwise 1.073 ml of 0.01 M hydrochloric acid, and the mixture was stirred at 5° C. for 1 hour. To the obtained solution was added dropwise 0.392 ml of a solution of malonic acid diluted by 10 times in terms of mass ratio with isopropyl alcohol, and the mixture was stirred at 5° C. for 2 hours to prepare a sample solution 3. 5.000 ml of the sample solution 3, 74.866 ml of isopropyl alcohol, 20.000 ml of water, and 0.134 ml of a solution of the compound 1 diluted by 100 times in terms of mass ratio with isopropyl alcohol were mixed to prepare a coating solution 5.

### Example 6

A coating solution 6 was prepared in the same manner as in Example 5 except that in preparation of the coating solution, the amount of the sample solution 3 was changed to 3.333 ml, the amount of isopropyl alcohol was changed to 76.577 ml, the amount of water was changed to 20.000 ml, and the amount of the solution of the compound 1 diluted by 100 times in terms of mass ratio with isopropyl alcohol was changed to 0.089 ml.

### Example 7

A coating solution 7 was prepared under the same conditions as in Example 4 except that with respect to Example 4, a compound with the average of n10 being 9 in (I-I-51) shown in Table 5-1 above (hereinafter, referred to as a compound 2) was used instead of the compound 1, as the compound (C1), in preparation of the coating solution.

### Example 8

A coating solution 8 was prepared under the same conditions as in Example 4 except that with respect to Example 4, a compound with the average of n10 being 45 in (I-I-51) shown in Table 5-1 above (hereinafter, referred to as a compound 3) was used instead of the compound 1, as the compound (C1), in preparation of the coating solution.

### Example 9

A coating solution 9 was prepared under the same conditions as in Example 4 except that with respect to Example 4, a compound with the average of n10 being 3 in (I-I-76) shown in Table 5-2 above (hereinafter, referred to as a compound 4) was used instead of the compound 1, as the compound (C1), in preparation of the coating solution.

### Example 10

A coating solution 10 was prepared under the same conditions as in Example 4 except that with respect to Example 4, a compound with the average of n10 being 3 in (I-I-26) shown in Table 4-2 above (hereinafter, referred to as a compound 5) was used instead of the compound 1, as the compound (C1), in preparation of the coating solution.

### Example 11

A coating solution 11 was prepared under the same conditions as in Example 4 except that with respect to Example 4, “X-24-9011” manufactured by Shin-Etsu Chemical Co., Ltd. was used instead of the compound 1, as the compound (C1), in preparation of the coating solution.

### Example 12

A coating solution 12 was prepared under the same conditions as in Example 4 except that with respect to Example 4, “KR-410” manufactured by Shin-Etsu Chemical Co., Ltd. was used instead of the compound 1, as the compound (C1), in preparation of the coating solution.

### Example 13

A coating solution 13 was prepared under the same conditions as in Example 4 except that with respect to Example 4, “DMS-S12” manufactured by Gelest Inc. was used instead of the compound 1, as the compound (C1), in preparation of the coating solution.

### Example 14

2.08×10⁻³ moles of n-octyltrimethoxysilane as the organosilicon compound (A) and 2.08×10⁻³ moles of tetraethyl orthosilicate (tetraethoxysilane) as the organosilicon compound (B) were dissolved in 2.456 ml of isopropyl alcohol (2-propanol), and the solution was stirred at 5° C. for 10 minutes. To the obtained solution was added dropwise 1.073 ml of 0.01 M hydrochloric acid, and the mixture was stirred at 5° C. for 1 hour. To the obtained solution was added dropwise 0.348 ml of a solution of malonic acid diluted by 10 times in terms of mass ratio with isopropyl alcohol, and the mixture was stirred at 5° C. for 2 hours to prepare a sample solution 4. 5.000 ml of the sample solution 4, 74.866 ml of isopropyl alcohol, 20.000 ml of water, and 0.134 ml of a solution of the compound 1 diluted by 100 times in terms of mass ratio with isopropyl alcohol were mixed to prepare a coating solution 14.

### Example 15

2.04×10⁻³ moles of n-dodecyltrimethoxysilane as the organosilicon compound (A) and 2.05×10⁻³ moles of tetraethyl orthosilicate (tetraethoxysilane) as the organosilicon compound (B) were dissolved in 2.456 ml of isopropyl alcohol (2-propanol), and the solution was stirred at 5° C. for 10 minutes. To the obtained solution was added dropwise 1.073 ml of 0.01 M hydrochloric acid, and the mixture was stirred at 5° C. for 1 hour. To the obtained solution was added dropwise 0.352 ml of a solution of malonic acid diluted by 10 times in terms of mass ratio with isopropyl alcohol, and the mixture was stirred at 5° C. for 2 hours to prepare a sample solution 5. 5.000 ml of the sample solution 5, 74.866 ml of isopropyl alcohol, 20.000 ml of water, and 0.134 ml of a solution of the compound 1 diluted by 100 times in terms of mass ratio with isopropyl alcohol were mixed to prepare a coating solution 15.

### Example 16

2.17×10⁻³ moles of n-decyltrimethoxysilane as the organosilicon compound (A) and 2.17×10⁻³ moles of tetraethyl orthosilicate (tetraethoxysilane) as the organosilicon compound (B) were dissolved in 2.417 ml of isopropyl alcohol (2-propanol), and the solution was stirred at 22° C. for 10 minutes. To the obtained solution was added dropwise 1.073 ml of 0.01 M hydrochloric acid, and the mixture was stirred at 22° C. for 1 hour. To the obtained solution was added dropwise 0.392 ml of a solution of malonic acid diluted by 10 times in terms of mass ratio with isopropyl alcohol, and the mixture was stirred at 22° C. for 2 hours to prepare a sample solution 16. 5.000 ml of the sample solution 16, 74.866 ml of isopropyl alcohol, 20.000 ml of water, and 0.134 ml of a solution as the compound (C1), in which the compound 1 with the average of n10 being 24 in (I-I-26) shown in Table 4-2 above was diluted by 100 times in terms of mass ratio with isopropyl alcohol, were mixed to prepare a coating solution 16.

### Comparative Example 1

1.84×10⁻⁴ moles of n-decyltrimethoxysilane as the organosilicon compound (A) and 4.79×10⁻³ moles of tetraethyl orthosilicate (tetraethoxysilane) as the organosilicon compound (B) were dissolved in 2.5 ml of isopropyl alcohol (2-propanol), and the solution was stirred at room temperature (25° C.) for 20 minutes. To the obtained solution was added dropwise 1.4 ml of 0.01 M hydrochloric acid, and the mixture was stirred for 24 hours after the start of the liquid preparation to prepare a comparative sample solution 1. The comparative sample solution 1 was diluted by 30 times in terms of volume ratio with isopropyl alcohol to prepare a coating solution 17.

Tables 7-1 to 7-3 show the compositions of the coating solutions. The amount of isopropyl alcohol shown in Tables 7-1 to 7-3 is a value when the total amount of the coating solution is 100 mass %.

TABLE 7-1

| | | | Example | Example | Example | Example | Example | Example |
|---|---|---|---|---|---|---|---|---|
| | | | 1 | 2 | 3 | 4 | 5 | 6 |
| Organosilicon | n- | Mass % | 0.713 | 0.476 | 0.713 | 0.476 | 0.713 | 0.476 |
| compound (A) | Decyltrimethoxysilane | | | | | | | |
| | n- | Mass % | — | — | — | — | — | — |
| | Octyltrimethoxysilane | | | | | | | |
| | n- | Mass % | — | — | — | — | — | — |
| | Dodecyltrimethoxysilane | | | | | | | |
| Organosilicon | Tetraethoxysilane | Mass % | 0.568 | 0.380 | 0.568 | 0.380 | 0.568 | 0.380 |
| compound (B) | | | | | | | | |
| Organosilicon compound (A) + | | Mass % | 1.281 | 0.856 | 1.281 | 0.856 | 1.281 | 0.856 |
| organosilicon compound (B) | | | | | | | | |
| Organosilicon compound (B)/ | | Molar ratio | 1.0 | 1.0 | 1.0 | 1.0 | 1.0 | 1.0 |
| organosilicon compound (A) | | | | | | | | |
| Catalyst (F) | Hydrochloric acid | Mass % | 0.0005 | 0.0003 | 0.0005 | 0.0003 | 0.0005 | 0.0003 |
| Catalyst (F)/[organosilicon compound (A) + | | Mass ratio | 0.00039 | 0.00035 | 0.00039 | 0.00035 | 0.00039 | 0.00035 |
| organosilicon compound (B)] | | | | | | | | |
| Weak acid (G) | Malonic acid | Mass % | 0.025 | 0.017 | 0.025 | 0.017 | 0.025 | 0.017 |
| Solvent (E) | Isopropyl alcohol | Mass % | 73.26 | 74.09 | 73.26 | 74.09 | 73.26 | 74.09 |
| Water (D) | | Mass % | 25.42 | 25.03 | 25.42 | 25.03 | 25.42 | 25.03 |
| Water (D)/organosilicon compound (A) | | Mass ratio | 36 | 53 | 36 | 53 | 36 | 53 |
| Compound (C1) | Compound 1 | Mass % | 0.0012 | 0.0008 | 0.0012 | 0.0008 | 0.0012 | 0.0008 |
| | Compound 2 | Mass % | — | — | — | — | — | — |
| | Compound 3 | Mass % | — | — | — | — | — | — |
| | Compound 4 | Mass % | — | — | — | — | — | — |
| | Compound 5 | Mass % | — | — | — | — | — | — |
| | X-24-9011 | Mass % | — | — | — | — | — | — |
| | KR-410 | Mass % | — | — | — | — | — | — |
| | DMS-S12 | Mass % | — | — | — | — | — | — |

| | | | | | | | |
|---|---|---|---|---|---|---|---|
| Compound (C1)/organosilicon compound (A) | Molar ratio | 2.1 × 10⁻⁴ | 2.1 × 10⁻⁴ | 2.1 × 10⁻⁴ | 2.1 × 10⁻⁴ | 2.1 × 10⁻⁴ | 2.1 × 10⁻⁴ |
| Compound (C1)/[organosilicon compound (A) + | Mass ratio | 0.000937 | 0.000935 | 0.000937 | 0.000935 | 0.000937 | 0.000935 |
| organosilicon compound (B)] | | | | | | | |
| organosilicon compound (A) + | Mass % | 1.282 | 0.857 | 1.282 | 0.857 | 1.282 | 0.857 |
| organosilicon compound (B) + compound (C1) | | | | | | | |

TABLE 7-2

| | | | Example | Example | Example | Example | Example | Example |
|---|---|---|---|---|---|---|---|---|
| | | | 7 | 8 | 9 | 10 | 11 | 12 |
| Organosilicon | n- | Mass % | 0.476 | 0.476 | 0.476 | 0.476 | 0.476 | 0.476 |
| compound (A) | Decyltrimethoxysilane | | | | | | | |
| | n- | Mass % | — | — | — | — | — | — |
| | Octyltrimethoxysilane | | | | | | | |
| | n- | Mass % | — | — | — | — | — | — |
| | Dodecyltrimethoxysilane | | | | | | | |
| Organosilicon | Tetraethoxysilane | Mass % | 0.380 | 0.380 | 0.380 | 0.380 | 0.380 | 0.380 |
| compound (B) | | | | | | | | |
| Organosilicon compound (A) + | | Mass % | 0.856 | 0.856 | 0.856 | 0.856 | 0.856 | 0.856 |
| organosilicon compound (B) | | | | | | | | |
| Organosilicon compound (B)/ | | Molar ratio | 1.0 | 1.0 | 1.0 | 1.0 | 1.0 | 1.0 |
| organosilicon compound (A) | | | | | | | | |
| Catalyst (F) | Hydrochloric acid | Mass % | 0.0003 | 0.0003 | 0.0003 | 0.0003 | 0.0003 | 0.0003 |
| Catalyst (F)/[organosilicon compound (A) + | | Mass ratio | 0.00035 | 0.00035 | 0.00035 | 0.00035 | 0.00035 | 0.00035 |
| organosilicon compound (B)] | | | | | | | | |
| Weak acid (G) | Malonic acid | Mass % | 0.017 | 0.017 | 0.017 | 0.017 | 0.017 | 0.017 |
| Solvent (E) | Isopropyl alcohol | Mass % | 74.09 | 74.09 | 74.09 | 74.09 | 74.09 | 74.09 |
| Water (D) | | Mass % | 25.03 | 25.03 | 25.42 | 25.03 | 25.42 | 25.03 |
| Water (D)/organosilicon compound (A) | | Mass ratio | 53 | 53 | 53 | 53 | 53 | 53 |
| Compound (C1) | Compound 1 | Mass % | — | — | — | — | — | — |
| | Compound 2 | Mass % | 0.0008 | — | — | — | — | — |
| | Compound 3 | Mass % | — | 0.0008 | — | — | — | — |
| | Compound 4 | Mass % | — | — | 0.0008 | — | — | — |
| | Compound 5 | Mass % | — | — | — | 0.0008 | — | — |
| | X-24-9011 | Mass % | — | — | — | — | 0.0008 | — |
| | KR-410 | Mass % | — | — | — | — | — | 0.0008 |
| | DMS-S12 | Mass % | — | — | — | — | — | — |

| | | | | | | | |
|---|---|---|---|---|---|---|---|
| Compound (C1)/organosilicon compound (A) | Molar ratio | 2.1 × 10⁻⁴ | 2.1 × 10⁻⁴ | 2.1 × 10⁻⁴ | 2.1 × 10⁻⁴ | 2.1 × 10⁻⁴ | 2.1 × 10⁻⁴ |
| Compound (C1)/[organosilicon compound (A) + | Mass ratio | 0.000935 | 0.000935 | 0.000935 | 0.000935 | 0.000935 | 0.000935 |
| organosilicon compound (B)] | | | | | | | |
| organosilicon compound (A) + | Mass % | 0.857 | 0.857 | 0.857 | 0.857 | 0.857 | 0.857 |
| organosilicon compound (B) + compound (C1) | | | | | | | |

TABLE 7-3

| | | | Example | Example | Example | Example | Comparative |
|---|---|---|---|---|---|---|---|
| | | | 13 | 14 | 15 | 16 | Example 1 |
| Organosilicon | n- | Mass % | 0.476 | — | — | 0.713 | 0.041 |
| compound (A) | Decyltrimethoxysilane | | | | | | |
| | n- | Mass % | — | 0.482 | — | — | — |
| | Octyltrimethoxysilane | | | | | | |
| | n- | Mass % | — | — | 0.496 | — | — |
| | Dodecyltrimethoxysilane | | | | | | |
| Organosilicon | Tetraethoxysilane | Mass % | 0.380 | 0.364 | 0.357 | 0.568 | 0.849 |
| compound (B) | | | | | | | |
| Organosilicon compound (A) + | | Mass % | 0.856 | 0.846 | 0.853 | 1.281 | 0.890 |
| organosilicon compound (B) | | | | | | | |
| Organosilicon compound (B)/ | | Molar ratio | 1.0 | 1.0 | 1.0 | 1.0 | 26.0 |
| organosilicon compound (A) | | | | | | | |
| Catalyst (F) | Hydrochloric acid | Mass % | 0.0003 | 0.0003 | 0.0003 | 0.0005 | 0.0004 |
| Catalyst (F)/[organosilicon compound (A) + | | Mass ratio | 0.00035 | 0.00035 | 0.00035 | 0.00039 | 0.00045 |
| organosilicon compound (B)] | | | | | | | |
| Weak acid (G) | Malonic acid | Mass % | 0.017 | 0.025 | 0.026 | 0.025 | — |
| Solvent (E) | Isopropyl alcohol | Mass % | 74.09 | 74.09 | 74.09 | 73.26 | 97.932 |
| Water (D) | | Mass % | 25.03 | 25.04 | 25.03 | 25.42 | — |
| Water (D)/organosilicon compound (A) | | Mass ratio | 53 | 52 | 51 | 36 | — |
| Compound (C1) | Compound 1 | Mass % | — | 0.0008 | 0.0008 | 0.0012 | — |
| | Compound 2 | Mass % | — | — | — | — | — |
| | Compound 3 | Mass % | — | — | — | — | — |
| | Compound 4 | Mass % | — | — | — | — | — |
| | Compound 5 | Mass % | — | — | — | — | — |
| | X-24-9011 | Mass % | — | — | — | — | — |
| | KR-410 | Mass % | — | — | — | — | — |
| | DMS-S12 | Mass % | 0.0008 | — | — | — | — |

| | | | | | | |
|---|---|---|---|---|---|---|
| Compound (C1)/organosilicon compound (A) | Molar ratio | 2.1 × 10⁻⁴ | 2.1 × 10⁻⁴ | 2.1 × 10⁻⁴ | 2.1 × 10⁻⁴ | — |
| Compound (C1)/[organosilicon compound (A) + | Mass ratio | 0.000935 | 0.000946 | 0.000938 | 0.000937 | — |
| organosilicon compound (B)] | | | | | | |
| organosilicon compound (A) + | Mass % | 0.857 | 0.847 | 0.854 | 1.282 | 0.890 |
| organosilicon compound (B) + compound (C1) | | | | | | |

For the obtained coating solutions 1 to 17, GPC chromatography analysis was performed to determine the weight average molecular weight (Mw). On the basis of the obtained chromatogram, the area ratio (Y/X) of a high-molecular-weight component (Y) having a molecular weight of more than 800 in terms of standard polyethylene glycol to a low-molecular-weight component (X) having a molecular weight of 500 or more and 800 or less in terms of standard polyethylene glycol was calculated. Table 8-1 or 8-2 shows the results of the calculation.

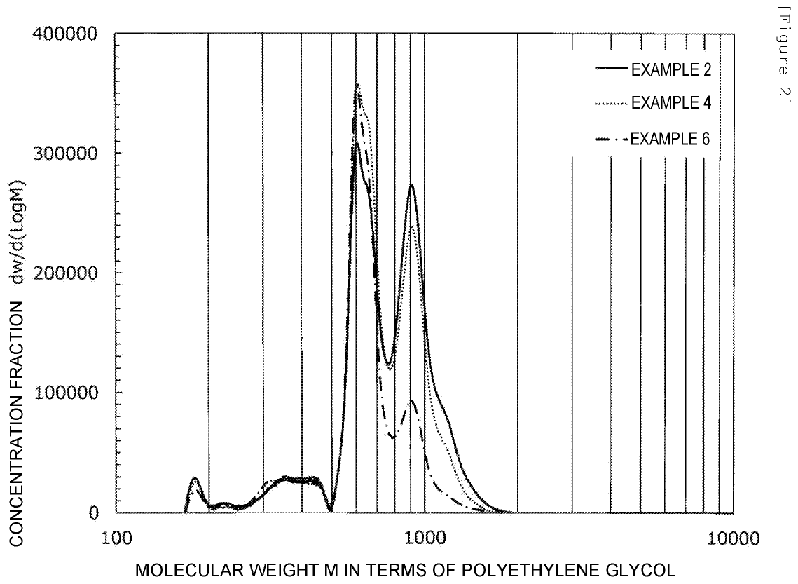

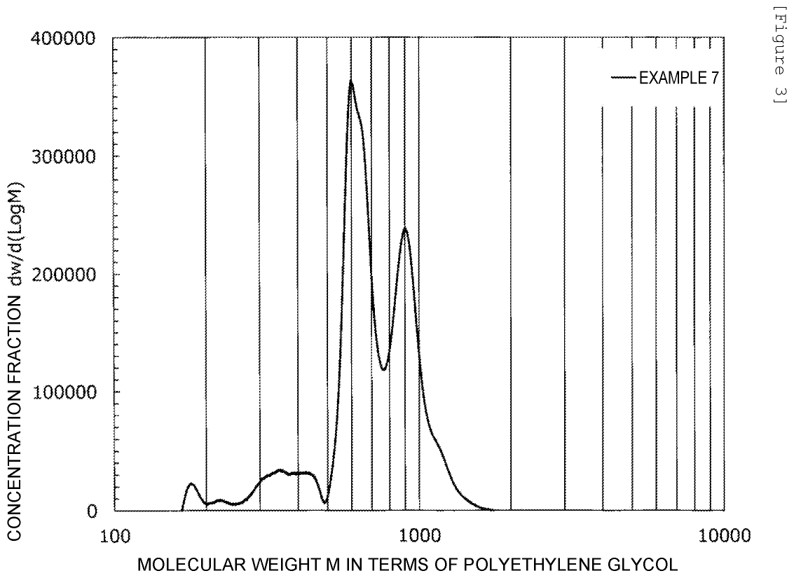

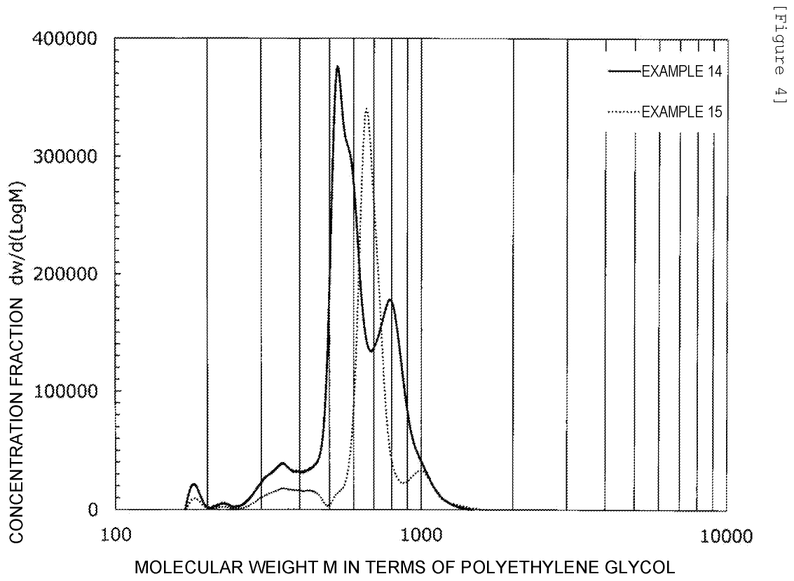

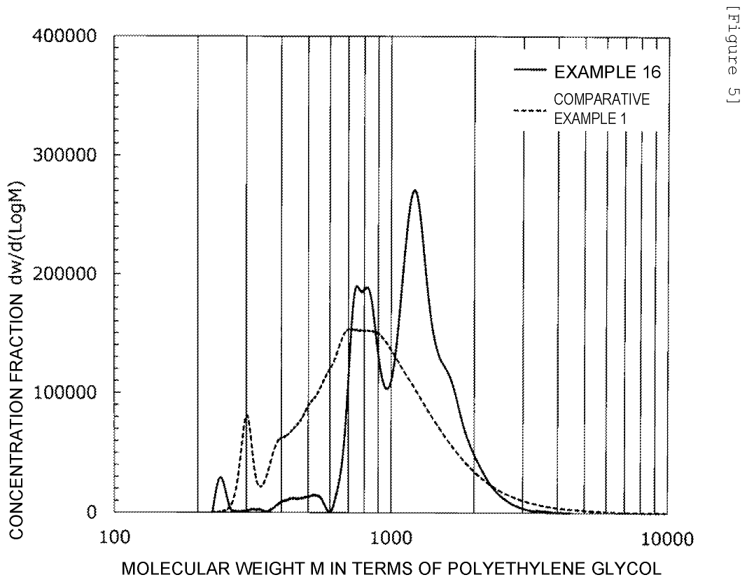

A differential molecular weight distribution curve was determined from the obtained chromatogram. FIGS. 1 to 5 show the determined differential molecular weight distribution curves. The abscissa represents the molecular weight in terms of standard polyethylene glycol, and the ordinate represents a concentration fraction. FIG. 1 shows differential molecular weight distribution curves for the coating solutions 1, 3 and 5 obtained in Examples 1, 3 and 5. FIG. 2 shows differential molecular weight distribution curves for the coating solutions 2, 4 and 6 obtained in Examples 2, 4 and 6. FIG. 3 shows a differential molecular weight distribution curve for the coating solution 7 obtained in Example 7. FIG. 4 shows differential molecular weight distribution curves for the coating solutions 14 and 15 obtained in Examples 14 and 15. FIG. 5 shows a differential molecular weight distribution curve for the coating solution 16 obtained in Example 16 and a differential molecular weight distribution curve for the coating solution 17 obtained in Comparative Example 1. Since the results of the differential molecular weight distribution curves for the coating solutions 8 to 13 obtained in Examples 8 to 13 are almost the same as the result of the differential molecular weight distribution curve for the coating solution 7, the result of the differential molecular weight distribution curve for the coating solution 7 is shown as a representative.

Next, a glass substrate of 5 cm×5 cm (soda lime glass, top surface) with a surface activated by atmospheric pressure plasma treatment was coated with each of the obtained coating solutions 1 to 17 by hand-coating using a nonwoven fabric. The amount of the coating solution applied was 0.5 ml. After the coating, the excess was wiped off with a microfiber cloth. After the coating, the costing solution was left to stand at normal temperature and normal humidity for 24 hours to perform curing, thereby forming a film on the glass substrate. The obtained film on the glass substrate was evaluated by the following method.

### [Measurement of Contact Angle]

Using DM 700 manufactured by Kyowa Interface Science Co., Ltd. as a contact angle measuring apparatus, the contact angle of a surface of the film with respect to water was measured by a liquid droplet method. The analysis method in the liquid droplet method was a θ/2 method, and the amount of water droplet was 3.0 μL.

### [Measurement of Slip Drop Angle]

Using DM 700 manufactured by Kyowa Interface Science Co., Ltd. as a contact angle measuring apparatus, the contact angle hysteresis (slip drop angle) of a surface of the film with respect to water was measured by a slip drop method, and the dynamic water-repellent property of a surface of the film was evaluated. The analysis method in the slip drop method was a tangent method, and the amount of water droplet was 30 μL. The method for setting slope was continuous sloping, and slip drop detection was performed after slip drop. Determination of movement was based on an angle of advancement, and the slip drop determination distance was 0.25 mm.

### [Measurement of Slip Drop Speed]

Water was dropped to a surface of the film, the slip drop speed of the water droplet on the surface of the film was measured, and the water-repellent property of the surface of the film was evaluated. Specifically, using DM 700 manufactured by Kyowa Interface Science Co., Ltd. as a contact angle measuring apparatus, 20 μL of water was dropped to a surface of the film formed on a glass substrate inclined at 25°, the time until slip drop of the water droplet by 15 mm from the initial dropping position was measured, and the slip drop speed (mm/sec) of the water droplet on the surface of the film was calculated.

Table 8-1 or 8-2 below shows the results of the measurements of contact angles, slip drop angles and slip drop speeds as initial water-repellent properties.

Next, the obtained coating solutions 1 to 17 were held at 50° C. for 1 month. After the holding, a film was formed on a glass substrate in the same manner as in Example 1 above. For the obtained film on the substrate, the contact angle, the slip drop angle and the slip drop speed were measured by the above-described methods. Table 8-1 or 8-2 below shows the results of the measurements of contact angles, slip drop angles and slip drop speeds after the holding as water-repellent properties after holding.

The wipe-off property was sensorily evaluated in accordance with the following criteria on the basis of a texture felt between the microfiber cloth and the wiped surface when the excess was wiped off with the microfiber cloth after coating with the coating solution. As the microfiber cloth, one manufactured by J&M Company was used. The excess was wiped off until it was possible to visually confirm that the wiped surface was transparent. Table 8-1 or 8-2 below shows the results of evaluations of the wipe-off property.

### [Criterial for Evaluation of Wipe-Off Property]

Score 0: Resistance is not felt.

Score 1: Weak resistance is felt during removal of the excess on the outermost surface.

Score 2: Weak resistance is felt during and after removal of the excess on the outermost surface.

Score 3: Strong resistance is felt during and after removal of the excess on the outermost surface.

TABLE 8-1

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Molecular weight: 500 to | Number | Count | 2 | 2 | 1 | 1 | 1 | 1 | 1 | 1 |
| 2000 Concentration | of peaks | | | | | | | | | |
| fraction: 250000 or more | | | | | | | | | | |
| Molecular weight: 500 to | Number | Count | 1 | 1 | 1 | 1 | 1 | 1 | 1 | 1 |
| 800 Concentration | of peaks | | | | | | | | | |
| fraction: 200000 or more | | | | | | | | | | |
| Area ratio high-molecular- | | — | 1.3 | 1.4 | 1 | 1.1 | 0.4 | 0.4 | 1.0 | 1.0 |
| weight component Y/low- | | | | | | | | | | |
| molecular-weight component X | | | | | | | | | | |
| Weight average molecular | | — | 780 | 770 | 726 | 735 | 637 | 655 | 719 | 730 |
| weight Mw | | | | | | | | | | |
| Initial water-repellent | Contact | Degree | 109.1 | 107.9 | 106.1 | 106.7 | 106.7 | 107.1 | 107.6 | 107 |
| property | angle | | | | | | | | | |
| | Slip drop | Degree | 12.5 | 13.5 | 13.0 | 14.0 | 13.0 | 15.0 | 12.0 | 13.5 |
| | angle | | | | | | | | | |
| | Slip drop | mm/sec | 83.5 | 104.8 | 94.5 | 91.6 | 89.9 | 92.5 | 88.1 | 88.0 |
| | speed | | | | | | | | | |
| Water-repellent property | Contact | Degree | 105.7 | 107.3 | 106.0 | 106.8 | 106.8 | 106.9 | 108.2 | 108.6 |
| after storage | angle | | | | | | | | | |
| | Slip drop | Degree | 18.0 | 14.5 | 14.0 | 14.5 | 16.0 | 14.0 | 10.5 | 10.0 |
| | angle | | | | | | | | | |
| | Slip drop | mm/sec | 77.8 | 77.4 | 85.9 | 70.5 | 75.6 | 70.6 | 88.5 | 87.9 |
| | speed | | | | | | | | | |

| | | | | | | | | | |
|---|---|---|---|---|---|---|---|---|---|
| Wipe-off property after storage | Score | 0 | 0 | 0 | 0 | 0 | 0 | 0 | 0 |

TABLE 8-2

| | | | Example | Example | Example | Example | Example | Example | Example | Example | Comparative |
|---|---|---|---|---|---|---|---|---|---|---|---|
| | | | 9 | 10 | 11 | 12 | 13 | 14 | 15 | 16 | Example 1 |
| Molecular weight: 500 to | Number | Count | 1 | 1 | 1 | 1 | 1 | 1 | 1 | 1 | 0 |
| 2000 Concentration | of peaks | | | | | | | | | | |
| fraction: 250000 or more | | | | | | | | | | | |
| Molecular weight: 500 to | Number | Count | 1 | 1 | 1 | 1 | 1 | 1 | 1 | 0 | 0 |
| 800 Concentration | of peaks | | | | | | | | | | |
| fraction: 200000 or more | | | | | | | | | | | |
| Area ratio high-molecular- | | — | 1.0 | 1.0 | 1.0 | 1.0 | 1.0 | 0.8 | 0.7 | 2.5 | 5.6 |
| weight component Y/low- | | | | | | | | | | | |
| molecular-weight component X | | | | | | | | | | | |
| Weight average molecular | | — | 730 | 723 | 724 | 729 | 732 | 624 | 678 | 865 | 968 |
| weight Mw | | | | | | | | | | | |
| Initial water-repellent | Contact | Degree | 107.3 | 106.4 | 107.9 | 106.7 | 107.9 | 107 | 108.5 | 108.2 | 109.1 |
| property | angle | | | | | | | | | | |
| | Slip | Degree | 12.0 | 13.5 | 14.5 | 15.0 | 12.5 | 13.0 | 13.5 | 10.5 | 16.3 |
| | drop | | | | | | | | | | |
| | angle | | | | | | | | | | |
| | Slip | mm/sec | 70.8 | 85.6 | 83.5 | 72.7 | 87.8 | 69.9 | 78.2 | 112.8 | 84.8 |
| | drop | | | | | | | | | | |
| | speed | | | | | | | | | | |
| Water-repellent property | Contact | Degree | 108.2 | 108.5 | 108.5 | 108.2 | 108.5 | 106.1 | 108.3 | 107 | 88 |
| after storage | angle | | | | | | | | | | |
| | Slip | Degree | 7.5 | 10.5 | 11.5 | 8.5 | 9.5 | 11.5 | 10.5 | 12.5 | ≥30 |
| | drop | | | | | | | | | | |
| | angle | | | | | | | | | | |
| | Slip | mm/sec | 93.6 | 93 | 90.0 | 87.7 | 87.4 | 80.95 | 80.95 | 87.9 | 0 |
| | drop | | | | | | | | | | |
| | speed | | | | | | | | | | |

| | | | | | | | | | | |
|---|---|---|---|---|---|---|---|---|---|---|
| Wipe-off property after storage | Score | 0 | 0 | 0 | 0 | 0 | 0 | 0 | 1 | 3 |

The coating solutions 1 to 16 which are curable compositions satisfying the requirements specified in the present invention have at least one peak with a concentration fraction of 250000 or more in a range where the molecular weight in terms of standard polyethylene glycol is 500 or more and 2000 or less in a differential molecular weight distribution curve determined from a chromatogram obtained by GPC chromatography. The peak may be derived from a condensate having an alkyl group having 6 to 30 carbon atoms.

The films obtained using the coating solutions 1 to 16 had a large contact angle, a small slip drop angle, a large slip drop speed and a good water-repellent property. The films formed after storage of the coating solutions 1 to 16 at 50° C. for 1 month also had a large contact angle, a small slip drop angle, a large slip drop speed and a good water-repellent property, and the coating solutions 1 to 16 were shown to be excellent in storage stability. It was shown that even when films were formed after storage of the coating solutions 1 to 16 at 50° C. for 1 month, a good wipe-off property and excellent workability were attained.

On the other hand, the coating solution 17 is a curable composition which does not satisfy the requirements specified in the present invention. The coating solution 17 did not have a peak with a concentration fraction of 250000 or more in a range where the molecular weight in terms of standard polyethylene glycol is 500 or more and 2000 or less in a differential molecular weight distribution curve determined from a chromatogram obtained by GPC chromatography. The film obtained using the coating solution 17 had a large contact angle, a small slip drop angle, a large slip drop speed and a good water-repellent property, but the film formed after storage of the coating solution 17 at 50° C. for 1 month had a large slip drop angle, a slip drop speed of 0 and a poor water-repellent property, revealing that storage stability was not improved. The film formed after storage of the coating solution 17 at 50° C. for 1 month had a poor wipe-off property, revealing that workability was not improved.

1. A curable composition comprising a condensate having an alkyl group having 6 to 30 carbon atoms,
wherein the curable composition has at least one peak with a concentration fraction of 250000 or more in a range where the molecular weight in terms of standard polyethylene glycol is 500 or more and 2000 or less in a differential molecular weight distribution curve determined from a chromatogram obtained by GPC chromatography.

2. The curable composition according to claim 1, wherein the curable composition has at least one peak with a concentration fraction of 200000 or more in a range where the molecular weight in terms of standard polyethylene glycol is 500 or more and 800 or less in the differential molecular weight distribution curve.

3. The curable composition according to claim 1, which is a mixed composition of an organosilicon compound (A) represented by formula (a1) and an organosilicon compound (B) represented by formula (b1):
R^{a1}—Si(X^{a1})₃ (a1)
wherein R^{a1} represents a hydrocarbon group having 6 to 30 carbon atoms; and
X^{a1} represents a hydrolyzable group, and
Si(R^{b1})_{b20}(X^{b1})_{4-b20} (b1)
wherein R^{b1} represents a hydrocarbon group having 1 to 5 carbon atoms;
X^{b1} represents a hydrolyzable group; and
b20 is 0 or 1.

4. The curable composition according to claim 3, wherein water (D) is mixed, and
the mass ratio (D/A) of the water (D) to the organosilicon compound (A) is 20 or more.

5. The curable composition according to claim 1, wherein in a chromatogram obtained by GPC chromatography of the curable composition, the ratio (Y/X) of a high-molecular-weight component (Y) having a molecular weight of more than 800 in terms of standard polyethylene glycol to a low-molecular-weight component (X) having a molecular weight of 500 or more and 800 or less in terms of standard polyethylene glycol is 3.0 or less.

6. The curable composition according to claim 1, wherein a compound (C1) represented by formula (c1) is mixed: 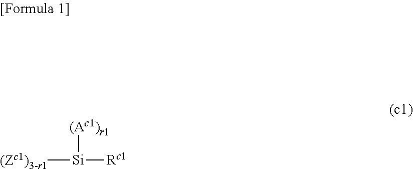
wherein A^{c1} represents a hydroxy group or a hydrolyzable group, and a plurality of A^{c1}s, when present, are optionally different from each other;
Z^{c1} represents a hydrocarbon group, a trialkylsilyl group-containing molecular chain or a siloxane backbone-containing group, and a plurality of Z^{c1}s, when present, are optionally different from each other;
r1 represents an integer of 1 to 3; and
R^{c1} represents a group represented by formula (c11): 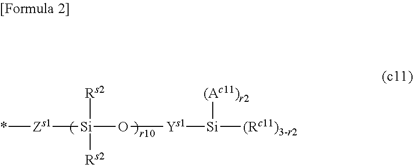
wherein R^{s2}s each independently represent an alkyl group having 1 to 4 carbon atoms;
R^{c11} represents a hydrocarbon group or a trialkylsilyloxy group, hydrogen atoms in the hydrocarbon group or the trialkylsilyloxy group are optionally replaced by fluorine atoms, and a plurality of R^{c11}s, when present, are optionally different from each other;
A^{c11} represents a hydroxy group or a hydrolyzable group, and a plurality of A^{c11}s, when present, are optionally different from each other;
Z^{s1} represents —O— or a divalent hydrocarbon group, and —CH₂— in the divalent hydrocarbon group is optionally replaced by —O—;
Y^{s1} represents a single bond or —Si(R^{s2})₂-L^{s1}-, L^{s1} represents a divalent hydrocarbon group, and —CH₂— in the divalent hydrocarbon group is optionally replaced by —O—;
r2 represents an integer of 0 to 3;
r10 represents an integer of 1 or more; and
* represents a bond.

7. The curable composition according to claim 6, wherein the compound (C1) is a compound represented by formula (c1-I): 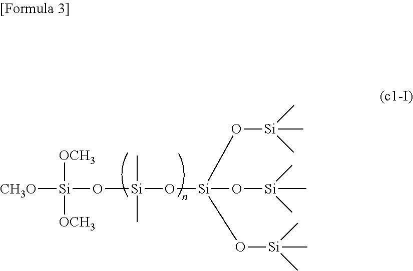
wherein n represents an integer of 1 to 60.

8. The curable composition according to claim 1, wherein a solvent (E) is mixed.

9. The curable composition according to claim 1, wherein a weak acid (G) having a pKa of 1 or more and 5 or less is mixed.

10. The curable composition according to claim 1, for use in formation of a liquid-repellent film.
